(19) United States
(12) Patent Application Publication
(10) Pub. No.: US 2022/0308577 A1
(43) Pub. Date: Sep. 29, 2022

(54) VIRTUAL TOWING DEVICE, SYSTEM, AND METHOD

(71) Applicant: Intel Corporation, Santa Clara, CA (US)

(72) Inventors: Frederik PASCH, Karlsruhe (DE); Fabian OBORIL, Karlsruhe (DE); Cornelius BUERKLE, Karlsruhe (DE)

(21) Appl. No.: 17/841,706

(22) Filed: Jun. 16, 2022

(51) Int. Cl. G05D 1/00; G05D 1/02; H04W 4/46; H04W 4/38; G07C 5/00; G07C 5/08

(52) U.S. Cl. CPC G05D 1/0027; G05D 1/0214; G05D 1/0223; H04W 4/46; H04W 4/38; G07C 5/006; G07C 5/008; G07C 5/0808; G05D 2201/0213

(57) ABSTRACT

Disclosed herein are devices, methods, and systems for providing virtual towing services from a towing vehicle to a towed vehicle. The device transmits a message indicating an offer to provide virtual towing services to the towed vehicle. The device activates a virtual towing mode based on acceptance of the offer. In the virtual towing mode, the device determines a pathway to a repair destination for the towing vehicle together with towed vehicle. The device determines a waypoint and a speed for the towing vehicle along the pathway based on a joint safety assessment of the towing vehicle and the towed vehicle and controls its movements accordingly. The device determines waypoint information and speed information for the towed vehicle based on a transformation of the waypoint and the speed from a first coordinate system of the towing vehicle to a second coordinate system of the towed vehicle.

### TECHNICAL FIELD

The disclosure relates generally to providing driving assistance to an autonomous and/or partially autonomous vehicle that may be unable to safely operate its automated and/or partially automated driving system due to, for example, an impaired vision/perception system.

### BACKGROUND

Many of today's vehicles include autonomous driving or partially autonomous driving systems that provide safe driving for the vehicle and/or include automated safety warning/reaction systems that assist a human driver to drive the vehicle safely. Such automated safety systems typically rely on computerized vision and perception systems that use sensor data about the vehicle, its environment, other nearby vehicles, and/or infrastructure information to safely plan a route, safely execute vehicle movements, and monitor for and react to unsafe objects/situations. If an aspect of the computerized vision/perception system fails, however, the automated safety system may not be able to provide safe autonomous driving and/or may not be able to properly provide safety assistance to a human driver.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an exemplary illustration of a helping vehicle providing virtual towing assistance to an impaired vehicle;

FIG. 2A shows an exemplary depiction of a helping vehicle responding to an impaired vehicle in order to provide virtual towing assistance;

FIG. 2B depicts an example of a helping vehicle providing translated waypoint information and/or target speed information as part of its virtual towing assistance to an impaired vehicle;

FIG. 3 shows an exemplary virtual towing system that may provide waypoint information and/or target speed information from the helping vehicle to an impaired vehicle in a virtual towing mode;

FIG. 4 shows an exemplary virtual towing system in which a helping vehicle and an impaired vehicle may exchange information before and after virtual towing has been enabled;

FIG. 5 illustrates exemplary safety envelopes of a helping vehicle, an impaired vehicle, and of a combined safety envelope of the helping vehicle and the impaired vehicle;

FIG. 6 illustrates a schematic drawing of a device for providing and/or utilizing virtual towing assistance between a helping vehicle and an impaired vehicle;

FIG. 7 depicts a schematic flow diagram of an exemplary method for a virtual towing system; and

FIG. 8 depicts a schematic flow diagram of an exemplary method for a virtual towing system.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

The apparatuses and methods described herein may be implemented using a hierarchical architecture, e.g., by introducing a hierarchical prioritization of usage for different types of users (e.g., low/medium/high priority, etc.), based on a prioritized access to the spectrum (e.g., with highest priority given to tier-1 users, followed by tier-2, then tier-3, etc.).

A “vehicle” may be understood to include any type of driven object. By way of example, a vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, or a rocket, among others.

The term “autonomous vehicle” may describe a vehicle capable of implementing at least one vehicle maneuver without driver input. A vehicle maneuver may describe or include a change in one or more of steering, braking, acceleration/deceleration, etc. of the vehicle. A vehicle may be described as autonomous even in case the vehicle is not fully automatic (for example, fully operational with driver input or without driver input). Autonomous vehicles may include those vehicles that can operate under driver control during certain time periods and without driver control during other time periods. Autonomous vehicles may also include vehicles that control only some aspects of vehicle navigation, such as steering (e.g., to maintain a vehicle course between vehicle lane constraints) or some steering operations under certain circumstances, but may leave other aspects of vehicle navigation to the driver during other circumstances (e.g., braking under certain circumstances). Autonomous vehicles may also include vehicles that share the control of one or more aspects of vehicle maneuver implementation/planning under certain circumstances (e.g., hands-on, such as responsive to a driver input) and vehicles that control one or more aspects of vehicle maneuvering under certain circumstances (e.g., hands-off, such as independent of driver input). Autonomous vehicles may also include vehicles that control one or more aspects of vehicle navigation under certain circumstances, such as under certain environmental conditions (e.g., spatial areas, roadway conditions). In some aspects, autonomous vehicles may handle some or all aspects of braking, speed control, velocity control, and/or steering of the vehicle

An autonomous vehicle may include those vehicles that can operate without a driver. The level of autonomy of a vehicle may be described or determined by the Society of Automotive Engineers (SAE) level of the vehicle (e.g., as defined by the SAE, for example in SAE J3016 2018: Taxonomy and definitions for terms related to driving automation systems for on road motor vehicles) or by other relevant professional organizations. The SAE level may have a value ranging from a minimum level, e.g. level 0 (illustratively, substantially no driving automation), to a maximum level, e.g. level 5 (illustratively, full driving automation).

As vehicles become more complex, it also becomes more likely that vehicles will breakdown or will become impaired in some way that prevents the vehicle from driving or being driven safely. With the large number of automobiles on the road today, by some estimates, one of those vehicles may breakdown every 7 minutes. This is especially true with automated vehicles, where there is are very high requirements for reliability, availability, and accuracy. Thus, a failure of even a small aspect of the safety system (e.g., aspects of the perception system, a faulty sensor, a failure of a communication system, etc.) may prevent the vehicle from verifying safe driving, necessitating that it stop driving to mitigate safety risks and investigate the failure, even if the remainder of the automated control system (e.g., steering, acceleration, braking, etc.) is still working properly. As one example, a failure of a single sensor (e.g., even a redundant sensor) may result in the perception system failing to meet required safety standards and therefore necessitating a vehicle stop/shut down. Typically, a technician must be dispatched to fix the issue or the vehicle must be physically towed to a vehicle repair center for diagnostics and repair. However, dispatching physical assistance (e.g., by a tow-truck and/or the presence of a human) to the location of an automated vehicle with a broken safety system is a labor-intensive and cost-intensive task, especially where the driving/control system may remain functional.

As should be apparent from the detailed disclosure below, the disclosed virtual towing system allows for an impaired autonomous vehicle to be virtually towed by a helping vehicle, which provides for a lower labor-intensive and lower cost-intensive solution than conventional ways of physically dispatching a tow-truck and/or person to the towing location to physically tow the broken autonomous vehicle to a repair center or for a technician to inspect and repair the vehicle at the breakdown location. The described virtual towing system allows another vehicle (e.g., another autonomous or partially autonomous vehicle) to virtually “tow” the broken autonomous vehicle without a physical connection between them. By sharing data between the broken vehicle and the towing vehicle (e.g., waypoint information, speed information, sensor information, etc.), the towing vehicle is able to substitute its perception and planning assistance for that of the broken vehicle, allowing the towing vehicle to help the broken vehicle safely navigate to a repair center. The described virtual towing system may allow the towing device to perform its standard perception, planning, and driving control tasks while also sending information about at least one new target waypoint (e.g., target coordinates) and information about at least one target speed (e.g., target velocity) to the broken vehicle. The, the broken vehicle (also called the towed vehicle or the impaired vehicle) need not engage its impaired perception system and may simply operate its driving control system to maneuver the vehicle toward the provided target waypoint at the provided target speed.

In contrast to existing physical solutions, the described virtual towing system does not require a physical connection between the broken vehicle and the towing device, nor does the towed vehicle need to perform any of the planning, self-localization, or safety assessments that would normally be required as part of the automated driving system. The described virtual towing system may have further benefits over physical towing solutions, because the virtual towing system does not require an automobile, heavy vehicle, or tow-truck to provide physical towing and a drone, lightweight robot, or very small vehicle may operate as the virtual towing vehicle. In addition, the virtual towing vehicle does not need to be positioned strictly in front of the towed vehicle, as the virtual towing system may decide to position the towing vehicle above, below, behind, or to the side of the broken vehicle being towed. In addition, the towing vehicle may adapt its own behavior and the provided waypoint/speed information to reflect the specific impairment to the broken vehicle and its remaining, functional capabilities (e.g., physical restraints to its movement and/or safety capabilities). In addition, no portion of the broken vehicle's perception system (e.g., perception, localization, and planning tasks) needs to be functional in order be virtually towed using the virtual towing system described below. This means, for example, that even if all camera/vision systems have failed on the broken vehicle, the vehicle may still be virtually towed to the desired destination as long as the driving control systems (e.g., actuation, movement, motion systems, etc.) remain functional.

As noted above and as should be apparent from the description below, the virtual towing vehicle may be any type of vehicle (e.g., a human-driven vehicle, an autonomous automobile, a drone, lightweight robot, or even a very small vehicle) that is capable of obtaining/determining the location of itself and the towed vehicle and is able to share a target waypoint and target speed with the towed vehicle. Thus, while the description below discusses the virtual towing system from the exemplary perspective of an autonomous vehicle, this should not be understood as limiting, and these descriptions and examples should be understood to be applicable to any type of vehicle.

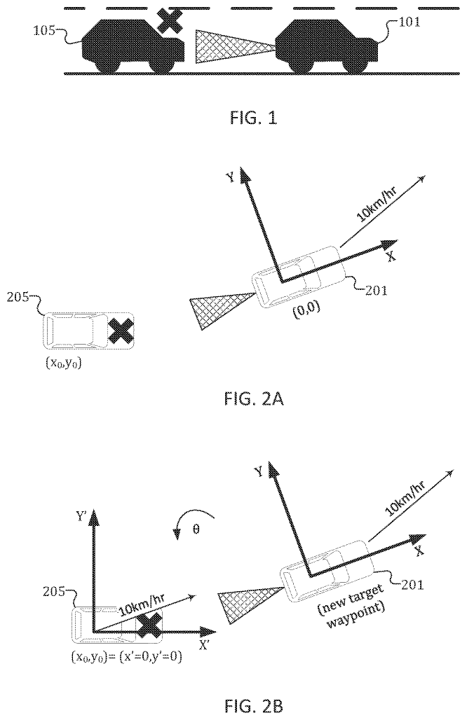

FIG. 1 shows an exemplary illustration of the virtual towing system where a helping vehicle provides virtual towing assistance to an impaired vehicle. A towing vehicle 101 (also called a “helping vehicle”) may respond to a request from impaired vehicle 105 (also called a “towed vehicle” or “broken vehicle”) by positioning itself in an appropriate location with respect to the impaired vehicle 105. Towing vehicle 101 and impaired vehicle 105 may communicate with one another (e.g., directly or indirectly, using a suitable communication protocol such as 5G, LTE, Bluetooth, WiFi, V2X, etc.) to exchange information and enable a virtual towing mode. Towing vehicle 101 may perform its standard driving tasks as well as a localization of the towed vehicle. The towing vehicle 101 may convert its own position into the coordinate system of the impaired vehicle 105, and then communicate this as target waypoint information and target speed information to the impaired vehicle 105. Impaired vehicle 105 may then simply “blindly” control its driving system to move to the received target waypoint at the target speed. As the impaired vehicle 105 approaches the target waypoint, the towing vehicle 101 will have already moved ahead to the next waypoint, and it may then share a new target waypoint based on its new position. As a result, both vehicles drive in tandem towards the desired location (e.g., towards a vehicle repair center/garage).

FIGS. 2A-2B show an exemplary virtual towing situation, where a towing vehicle converts its position/speed into waypoint and speed information for the towed vehicle. As shown in FIGS. 2A-2B, towing vehicle 201 is responding to a request from an impaired vehicle 205 for virtual towing assistance. In response to the request, the towing vehicle 201 has positioned itself in front of impaired vehicle 205 and both vehicles agree (e.g., via a communication handshake) to enable a virtual towing mode, where the towing vehicle 201 will provide waypoint and speed information to the impaired vehicle 205. Towing vehicle 201 may use sensor data (e.g., its own sensors and/or sensors data received from other vehicles or infrastructure equipment, etc.) to perceive the environment around itself, perform self-localization, and execute safety planning in the same way that it would if it were in a normal driving mode. In addition, the towing vehicle 201 may use information about the environment around the impaired vehicle 205 and perform safety planning that takes into account the dimensions, capabilities, and impairments of the impaired vehicle 205.

The towing vehicle 201 may also determine or obtain the pose (e.g., the x-, y-, and/or z-position and heading) of the impaired vehicle 205. Then, using this information, the towing vehicle 201 may convert its own position into the coordinate system of the impaired vehicle 205, such that this converted position may be provided to the impaired vehicle 205 as the next waypoint for the impaired vehicle 205. For example, if the new target waypoint is given by (wₓ, w_{y}) in the coordinate system of the towed vehicle 205, this target waypoint may be expressed as:

$$( {w}_{x} , {w}_{y} ) = [ \begin{matrix}cos ( θ ) & sin ( θ ) & {x}_{0} \\ - sin ( θ ) & cos ( θ ) & {y}_{0} \\ 0 & 0 & 1\end{matrix} ]$$

In the exemplary formula above, (x₀, y₀) may be understood as the current position of impaired vehicle 205 in the coordinate system of the towing vehicle 201, and θ is the rotation angle between the coordinate system of the towing vehicle 201 (e.g., indicated by axis Y and axis X) and the coordinate system of the impaired vehicle 205 (e.g., indicated by axis Y′ and axis X′). In other words, θ is the relative yaw of the impaired vehicle 205 as compared to the towing vehicle 201. Typically, the information needed for the towing vehicle 201 to convert its position into the coordinate system of the impaired vehicle 205 is available from the standard perception tasks of the towing vehicle 201 in a normal driving mode, so the virtual driving mode may not require additional perception tasks for the towing vehicle 201 to obtain this information. Then, the towing vehicle 201 may communicate information about the converted waypoint and the target speed to the impaired vehicle 205. Upon reception of the waypoint and speed information, the impaired vehicle 205 may generate its own driving commands (e.g., steering commands, throttle setting, etc.) to drive towards the provided waypoint at the provided speed. As should be appreciated, such driving commands may depend on the make, model, and/or manufacturer of the impaired vehicle 205. As such, the towing vehicle 201 may provide only waypoint and speed information rather than generating driving commands for the impaired vehicle 205. In this manner, the impaired vehicle 205 may use its own platform to generate appropriate driving commands for operating its driving system. As a result, both vehicles will move in tandem (e.g., accelerate/decelerate in the same way) and drive with the same speed (e.g., the target speed), and will therefore not collide with one another. As should be appreciated, the virtual towing mode may be operated in hardware and/or software on processors that may be separate from the processor(s) that operate other aspects of the vehicle. Though such separation is not required, separate processors may provide advantageous redundancy so that the virtual towing mode does not burden the normal driving processors and/or so that if a processor of the perception system is impaired, the virtual towing mode may still operate using another processor.

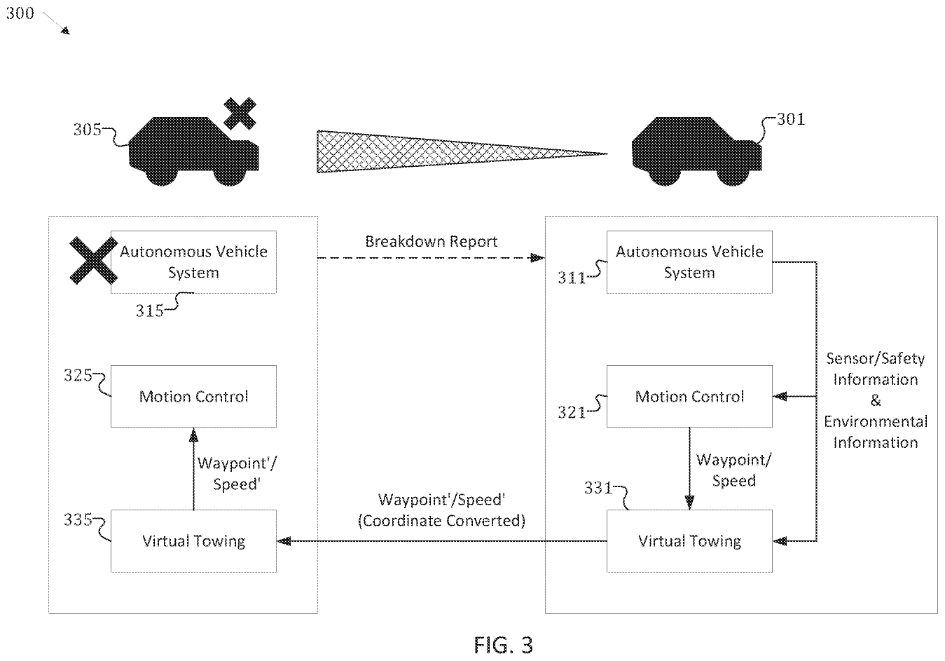

FIG. 3 shows an exemplary virtual towing system 300 that may provide waypoint information and/or target speed information from a helping vehicle 301 to an impaired vehicle 305. The impaired vehicle 305 may have an impaired autonomous vehicle driving system 315, where it can no longer safely operate the vehicle (e.g., due to a malfunctioning sensor or other aspect of its perception/safety system) even though the motion control system 325 is still functional. As such, the impaired vehicle 305 may broadcast a breakdown message that includes a breakdown report and seeks virtual towing assistance via its virtual towing module 335. A helping vehicle 301 may respond to the message and offer to provide virtual towing assistance via its virtual towing module 331. The helping vehicle 301 may confirm to the impaired vehicle 305 that it will provide the requested virtual towing assistance. The helping vehicle 301 may operate its autonomous vehicle system 311 and motion control system 321 as normal to perform perception, localization, and safety planning tasks, except that it may also take into account the location, pose, size, capabilities, etc. of the impaired vehicle 305. The virtual towing module 331 may utilize the information of the motion control system 321 and the autonomous vehicle system 311 to convert its waypoint and speed into the coordinate system of the impaired vehicle 335 (e.g., as coordinate converted waypoint′/speed′). The coordinate converted waypoint′/speed′ information may then be communicated to the impaired vehicle 305, where its virtual towing module 335 provides the coordinate converted waypoint′/speed′ to the motion control system 325 to operate the vehicle to approach the waypoint′ at the speed′.

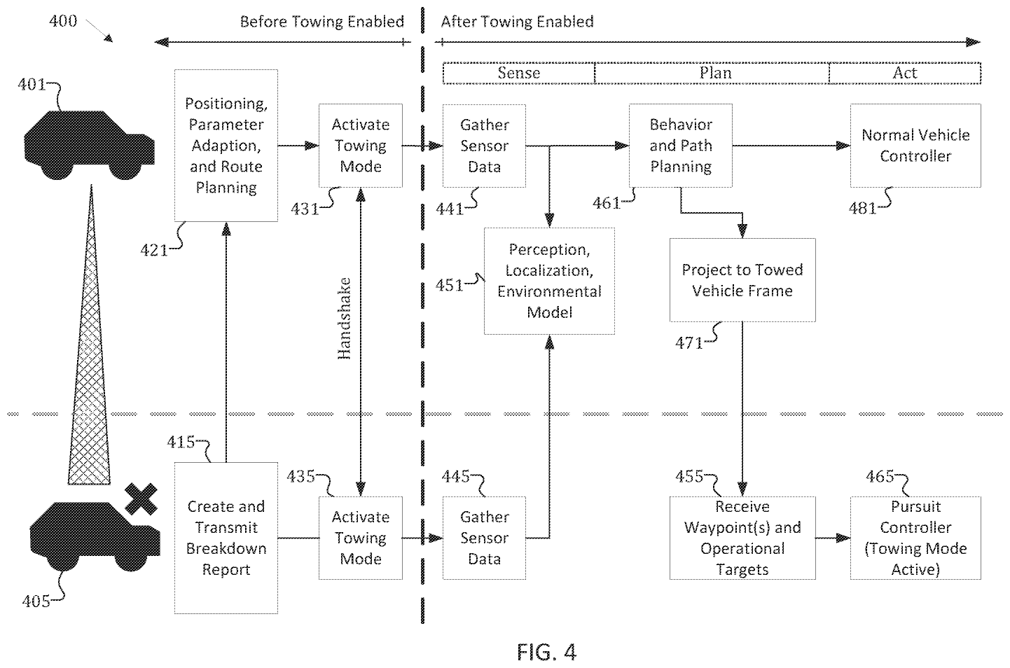

FIG. 4 shows an exemplary virtual towing system 400 in which a helping vehicle 401 and an impaired vehicle 405 may exchange information before and after virtual towing has been enabled. Initially, the impaired vehicle 405 may determine that a part of its automated driving system has become impaired, causing it to stop and, if possible, maneuver itself into a safe location with minimal risk. It may (in 415) create a breakdown report and may transmit (e.g., on a shared broadcast channel (e.g., WiFi, 5G, LTE, V2X, etc.), to a sever external to the impaired vehicle 405 (e.g. a cloud-based server), or on any other type of communication channel (e.g., directly to a nearby vehicle or vehicles)) a message with the breakdown report. The breakdown report may include information about the vehicle (e.g., dimensions), its capabilities (e.g., engine size, maximum acceleration, maximum breaking forces, average stopping distances, etc.), its operational status (weight of cargo, tire pressure, last known position, remaining gasoline, etc.), the nature of the impairment (e.g., which sensors are broken, which aspects of the perception system failed, what computational units have failed, etc.), and/or any other information that may be useful for the helping vehicle to account for the safety of the impaired vehicle 405 during towing. The breakdown message may be received by a helping vehicle 401 that may offer (e.g., as instructed by a service provider) to provide virtual towing services to the impaired vehicle 405.

The helping vehicle 401 may (in 421) determine how to position itself with respect to the impaired vehicle 405 (e.g., in front, behind, to the left/right side; what distance to maintain from the helping vehicle 401, etc.); adapt driving parameters so that they satisfy the safety needs of not only the helping vehicle 401 but also the impaired vehicle 405; and may determine a route to the desired vehicle repair facility/garage based on the parameters of the helping vehicle 401 and the impaired vehicle 405. For example, if a rearward-facing sensor of the impaired vehicle 405 has failed and the helping vehicle 401 determines that rearward facing sensor information is required for safety navigating to the service center destination, the helping vehicle 401 may position itself behind the impaired vehicle 405 (e.g., helping vehicle 401 may virtually “push” the impaired vehicle 405 from behind). As another example, if the breakdown report indicates that the left sensor array of the impaired vehicle 405 is damaged but the front, rear, and right sensor arrays are still functional, the helping vehicle 401 may determine to position itself on the left side of the vehicle and utilize the sensor data from the functioning sensors of impaired vehicle 405 in order to have maximum sensor coverage of the environment around both vehicles.

As another example, if the breakdown report indicates that the impaired vehicle 405 is carrying an unbalanced load that may not allow for fast acceleration/deceleration, the helping vehicle 401 may adapt its safety system to maintain a larger minimum distance to objects ahead. As another example, if the dimensions of the impaired vehicle 405 indicate that it is a very tall vehicle, the helping vehicle 401 may plan a route that avoids low underpasses that have a maximum allowable height that the impaired vehicle's height would exceed. As another example, if unprotected left-turns may not be possible when towing the impaired vehicle 401 (e.g., due to a lower range of coverage by available sensors), the helping vehicle 401 may plan a route without unprotected left turns and/or select a route with lower levels of traffic or that allows lower speeds to minimize risk. As should be appreciated, the helping vehicle 401 may utilize any information about the impaired vehicle 405 and the environment in order to perform positioning, adapt its safety/driving parameters, and plan the route to the desired vehicle service center/garage.

Next, the helping vehicle 401 and the impaired vehicle 405 may exchange a simple handshake to agree to enable the virtual towing mode (in 431 in the helping vehicle and in 435 in the impaired vehicle). Once enabled in both vehicles, the helping vehicle 405 will provide waypoint and speed information for the impaired vehicle 401 to use in its control system for maneuvering the impaired vehicle 401 to the waypoint at the speed. The virtual towing mode may be understood as three general phases of sensing, planning, and acting that are repeated as part of continuous process. In the sense phase, the helping vehicle 405 may (in 451) use its autonomous driving system for perception, localization, and to generate an environmental model of the area around one or both vehicles. For this, the helping vehicle 405 may gather sensor data (in 441), and if the impaired vehicle 405 has functioning sensors, the impaired vehicle 405 may also gather sensor data (in 445) that may be provided to the helping vehicle 401 for (in 451) perception, localization, and/or the environmental model. As should be understood, so as to simplify implementation of the virtual towing system, the helping vehicle 401 may utilize a perception, localization, and the environmental model that may already be part of the autonomous driving system (e.g., that would be used for normal autonomous driving). Of course, as noted above and discussed in more detail below, the safety parameters that may be used by the autonomous driving system may be adapted to accommodate the safety needs of the both vehicles.

In the planning phase, the helping vehicle 401 may perform behavior and planning (in 461) to determine its trajectory (e.g., waypoint(s) and speed) toward its destination (e.g., the service center). As with the perception, localization, and environmental modeling, the behavior and path planning may already be part of the autonomous driving system (e.g., that would be used for normal autonomous driving), except that the input parameters may be adapted to accommodate the behavioral/path needs of the both vehicles. In another part of the planning phase, the helping vehicle 401 may determine (in 471) a waypoint and speed for the impaired vehicle 405 by projecting its waypoint and speed information into the coordinate system (also called a reference “frame”) of the impaired vehicle 405. The coordinate-adjusted waypoint and speed information is then transmitted to the impaired vehicle 405. The impaired vehicle 405 receives (in 455) the coordinate-adjusted waypoint and speed information for use by its motion control system.

As should be appreciated, while target waypoint and target speed have been provided as examples of the information that is calculated, projected to the coordinate system of the impaired vehicle 405, and shared with the impaired vehicle 405, any type of target trajectory information (also converted into the coordinate system of the impaired vehicle 405) may be shared with the impaired vehicle 405. In addition, it should be appreciated that the trajectory information may be shared as a set of trajectories (e.g., a set of waypoints) that may be updated on a regular basis, rather than providing simply a single waypoint at a time. If such a list of waypoints is provided, the impaired vehicle 405 may be able to determine driving commands that approach the waypoints with a smoother trajectory (e.g., if a series of waypoints follow a curve in a road, the impaired vehicle 405 may issue driving commands that follow the curve defined by the waypoints but may not necessarily follow a straight line to each waypoint and may not necessarily traverse each waypoint along the curve).

In the act phase, the helping vehicle 401 uses (in 481) the unadjusted waypoint and speed in its vehicle controller to maneuver as normal to the current waypoint. The impaired vehicle 405 may use the received, coordinate-adjusted, previously provided waypoint and speed information to (in 465) control the vehicle to maneuver toward the coordinate-adjusted waypoint at the provided speed. In this sense, the impaired vehicle acts as a “pursuit controller” that simply follows the trajectories provided by the helping vehicle 401. Then, the process repeats and continues for the next waypoint or set of waypoints, where the current waypoint provided to the impaired vehicle 405 is the previous waypoint of the helping vehicle 401.

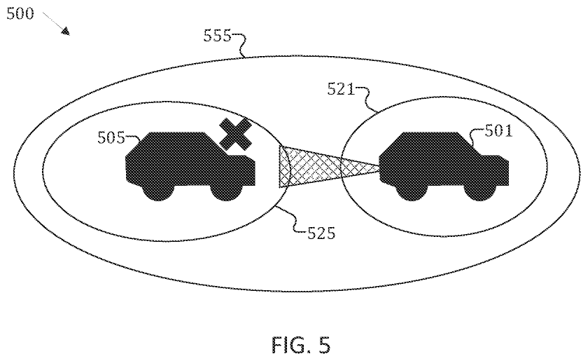

FIG. 5 illustrates exemplary safety envelopes of a helping vehicle, an impaired vehicle, and of a combined safety envelope of the helping vehicle and the impaired vehicle. As noted earlier, parameters that may be used by the autonomous driving system of the helping vehicle may be adapted to accommodate the safety needs of the both vehicles. Such parameters may influence what may be typically called “safety envelopes” that represent the maximum safe distances to other objections that the automated driving system should maintain vis-à-vis other objects when planning routes, trajectories, and movements of the vehicle. As shown in FIG. 5, helping vehicle 501 may be operating in a virtual towing mode to provide virtual towing services to impaired vehicle 505. In normal driving conditions, helping vehicle 501 may have safety envelope 521, while impaired vehicle 505 (when not impaired) may have safety envelope 525. When operating in a virtual towing mode, however, helping vehicle 501 may adjust its parameters used by the automated driving system so as to encompasses the dimensions, capabilities, and needs of the impaired vehicle 505, effectively establishing a combined safety envelope 555 that may be larger than just a superposition of the individual safety envelopes 525 and 521.

Any number of factors may be considered to establish the combined safety envelope 555, including factors such as capabilities of the impaired vehicle 505, the expected risk along the planned route, the dimensions (width, length, height) of the vehicles, the space needed between the helping vehicle 501 and the impaired vehicle 505, the particular impairments of the impaired vehicle 525, the available sensor data, etc. Thus, the helping vehicle 501 may adapt the parameter values it uses for safety considerations and behavior planning to account for the impaired vehicle 505 and the combined safety envelope 555. This means the helping vehicle 501 may adapt parameters such as maximum possible acceleration/deceleration, maximum breaking forces, average stopping distances, etc. based on the capabilities of the failed vehicle and/or the expected risks associated with towing the impaired vehicle 505 in tandem with the helping vehicle 501.

While the above examples of a virtual towing system have been described from the perspective of a single helping vehicle, it should be appreciated that multiple vehicles may provide virtual towing services to an impaired vehicle. For example, in cases where additional sensor data may be helpful (e.g., for large impaired vehicles where a front and rear helping vehicle may be needed to obtain sensor data that covers the full environment around the impaired vehicle) multiple vehicles may respond to the request for virtual towing services. Where multiple vehicles respond to an impaired vehicle's request for virtual towing services, one of the vehicles may be designated as the main or lead vehicle that determines and provides the waypoint and speed information to the impaired vehicle while the other vehicle(s) may simply provide sensor data to the main/lead vehicle.

As discussed above, the virtual towing system may be a continuous process in which the helping vehicle may continuously (e.g., in real-time, at predetermined interval(s), at predefined time(s), after an elapsed time period(s), at random times, etc.) provide new target waypoints (or a list of new target waypoints) as the vehicles move in tandem along the route. As should also be appreciated, it is possible that communications between the helping vehicle and the impaired vehicle may be lost or delayed while in the virtual towing mode. Thus, the impaired vehicle may be configured to decelerate or stop its movements (e.g., also called a “fail stop”) if it arrives within a predetermined distance of the target waypoint (or to the last waypoint in a list of target waypoints), as this may indicate that it should have already received a new target waypoint. If the helping vehicle detects an unexpected deceleration/stop of the impaired vehicle, the helping vehicle may also decelerate/stop and try to reestablish communications with the impaired vehicle (e.g., through a handshake procedure that verifies successful communication). In addition, the communication protocol between the helping vehicle and the impaired vehicle may utilize a “heartbeat” or “keep alive” protocol, where predefined messages are continuously exchanged and verified at predetermined time periods/intervals. If the predefined messages are not received/verified within the predetermined time period/interval, the vehicles may decelerate/stop until they successfully reestablish communication.

The virtual towing systems described above may also be used with a breakdown detection system for detecting that a vehicle's automated driving system is impaired such that the vehicle is in need of virtual towing assistance. The breakdown detection system may monitor and analyze input data from multiple sources in order to detect a failure. Typically, the breakdown detection system will be located in the vehicle, but the breakdown detection system may be distributed across many locations or fully located on a sever external to the vehicle (e.g., an edge-based or cloud-based server).

The breakdown detection system may receive reports from the vehicle (e.g., an in-vehicle reporting system, sensor reports, and/or the automated driving system itself) or from a passenger within the vehicle. The breakdown detection system may perform a plausibility check on the received report by comparing the report to the current/expected state of the automated driving system and/or the sensor data. If the breakdown detection system is distributed or edge/cloud-based, it may utilize infrastructure sensors or crowd-sourced sensor data to monitor for a breakdown, either from a breakdown message or from sensor data. Such sensor data may include data from cameras (e.g., red-greed-blue (RGB) or depth cameras), from radar, and/or from light-ranging and detection (LiDAR) sensors, which may detect that, for example, a vehicle is stopped on the shoulder of a highway for a longer-than-expected time. Thus, even where no communication is possible with the broken vehicle (e.g. because the wireless communication system may be defective), the breakdown detection system may still be capable of detecting the impaired vehicle through perception algorithms.

When some or all of the breakdown detection system is located in the edge/cloud, it may receive pre-processed input data from in-vehicle and edge-based systems and the breakdown detection system may be able to execute additional calculations to detect breakdowns and determine the severity of the breakdown (e.g., using a digital twin simulation, crowd-sourced data, artificial intelligence algorithms, etc. to predict the breakdown and/or its severity). Once a breakdown is confirmed, the breakdown detection system may report the breakdown to a countermeasure control system. Such a report may be sent internally via in-vehicle communication networks and externally via wireless networking (e.g. WiFi, LTE, Bluetooth, 5G, V2X, etc.).

If a vehicle breakdown occurs while passengers are on-board the vehicle, the countermeasure control system may provide information within the vehicle to alert the passengers to the breakdown by an acoustic sound/message and/or visual display. The message to the passengers may include the reason for the breakdown, when help may arrive, what countermeasures may be executed to address/resolve the error. As should be appreciated, the passengers may influence which countermeasures the countermeasure control system is to implement by, for example, answering questions or inputting responses into an on-screen display. For example, where multiple countermeasures may have the same likelihood of success, the countermeasure control system may request that the passenger select a preferred countermeasure. If a passenger is not able to answer the posed questions, the countermeasure control system might have an operator take over by calling the passenger and/or interacting with the system on behalf of the passenger.

For certain types of breakdowns (e.g. a sensor is faulty because it is covered by dust), the countermeasure control system may request that the passenger execute a countermeasure (e.g., remove the dust from the sensor). The countermeasure control system might provide a detailed description of how to execute the countermeasure. As should be appreciated, this might not only be technical in nature but may also be safety-related. For example, if a breakdown occurs on a busy highway with fast moving traffic, the countermeasure control system might instruct the passenger to exit the vehicle only via the doors towards the safe side (e.g. towards the shoulder) of the vehicle. The countermeasure execution system may be responsible for selecting an appropriate countermeasure and for its execution. The countermeasure execution system may use a distributed approach that is partially executed in the edge/cloud and partially executed within the vehicle, and the distribution may depend on the cause of the breakdown. Generally, the countermeasure execution system may execute the countermeasures so that the vehicle leaves a hazardous zone as quickly as possible. If the breakdown cannot be repaired immediately, the vehicle may need to be moved or towed to a safer place for further analysis (e.g. at repair shop or in a designated parking area).

The countermeasure execution system may select an appropriate countermeasure based input from the breakdown detection system. The countermeasure execution system may select the countermeasure based on its likelihood of success. This might include basing the countermeasure selection on crowd-sourced information about previous executions and/or using an artificial intelligence algorithm/learning model to assist selecting an optimal countermeasure based on the data from the breakdown detection system (e.g., breakdown reason, location, time of day, traffic situation, road condition/weather, etc.). Countermeasures may include: virtual towing (as discussed above), fallback sensory support, applying an immediate fix, allowing infrastructure to takeover control of the vehicle, etc.

The countermeasure execution system may implement fallback sensory support in multiple ways, including a degraded mode, using pre-equipped fallback sensors, attaching a new fallback sensor, or overriding the damaged part. In degraded mode, the automated driving system may use the remaining sensors of the vehicle, but with limited execution ranges such as reduced maximum speed, limited steering ranges, reduced acceleration/deceleration, etc. As should be appreciated, during the design phase of a vehicle, the automated driving system's sensors may be modeled to identify potential failure types and evaluate their severity. Each potential failure type may be identified by the sensor manufacturers or by public authorities. The severity evaluation may be a list of possible behavior models that depend on possible sensor failures. For example, if a long-range radar is malfunctioning the vehicle might need to limit the maximum speed. Or, if parts of a camera image are occluded, but other cameras still cover the visible range, the uncertainty may increase, so the vehicle may need to lower the speed significantly in order to remain safe. Or, if parts of a LiDAR detection range are occluded, the vehicle might need to prohibit sharp turns into the occluded direction. The degraded mode may utilize a look up table to query for appropriate countermeasures based on the type of sensor failure.

As another example of degraded mode, a cloud-based service may receive the sensory failure information, and a sensor model at the service may calculate whether and how a degraded mode might be applicable. If there are no fallback sensors that the vehicle may utilize as an alternative to the defective/degraded sensor, degraded mode may modify the behavior model of the vehicle. If, for example, the front-facing sensors of the vehicle are inoperative, the vehicle might still be able to execute movements that require only the back-facing sensors. That means a vehicle might switch to backward driving (e.g., operating the transmission in reverse) to reach a safe location. If passengers are on-board the vehicle, the degraded mode might first drop passengers off at the next safe position. As should be appreciated, the safe position for the passengers may be different from a safe position for the vehicle itself. For example, if a breakdown occurs on an inner lane of multilane highway, the first countermeasure of the vehicle may be to drop the passengers of at the road shoulder.

In pre-equipped fallback sensor mode, the countermeasure execution system might utilize redundant sensors that already exist on the vehicle. This may be similar to redundant head lights that may exists on road vehicles (e.g., low beam, high beam, and parking lights) that the vehicle may utilize if one set of head lights fails. One example of a pre-equipped fallback sensor may be a wide-angle, front-facing, robust RGB camera. A pre-equipped fallback sensor may allow the automated driving mode to operate according to a modified behavioral mode (e.g., move at a potentially slower speed that is safe when using the pre-equipped fallback sensor). The pre-equipped fallback sensor mode may be implemented during manufacturing of the vehicle or might be implemented by a cloud-based service on demand. One benefit of pre-equipped fallback sensor mode is that public authorities may be able to evaluate fallback behavior in advance to assure appropriate levels of safety for the fallback sensor mode.

The fallback sensory mode may also use sensors that are attached after the vehicle detects a breakdown. This is similar to how a spare wheel may be available in the vehicle as a replacement for a faulty tire. In this same sense, a sensor package may be later attached to a vehicle in order to substitute for a malfunctioning sensor. The sensor package may be added manually by a human (e.g., supported through instructions to the human by the vehicle's audio/video system) or automatically by an automated vehicle (e.g., a drone or mobile robot). The added sensor package may have a mechanical connection (e.g., magnetic, suction cups, a sensor package dock, etc.). In addition, the sensor package may have a data connection that could be established wirelessly (e.g., through WiFi, 5G, V2X, Bluetooth, LTE, etc.) or wired (e.g., through a specific sensor package plug). The sensor package may include robust sensors that allow the vehicle to maneuver to a safe location, which might include a wide-angle RGB camera, a depth camera, a LiDAR sensor, a radar sensor, etc. and may provide sensing in all relevant directions. The automated driving software may learn about the newly attached sensor package and its capabilities via a handshake procedure, and it may then adapt its driving behaviors according to the detected capabilities of the newly added sensor package.

In addition to or as an alternative to the fallback sensor mode, the countermeasure execution system may implement an override of the malfunctioning part(s), which may depend on the severity of the malfunction. If, for example, the defect is in part of the drivetrain (e.g. a damaged motor), the appropriate countermeasure may be to send out a vehicle (e.g. a drone or mobile robot) that may override the damaged part. For defects that are not easily reachable, an autonomous mobile platform may be used to lift the vehicle to enable easier access to the malfunctioning part. The countermeasure execution system may also simply apply an immediate fix as a countermeasure. For example, a multipurpose mobile robot or drone may be dispatched to execute a fixing routine on the malfunctioning sensor (e.g., cleaning a dirty sensor, recharging a drained battery of the sensor, etc.).

The countermeasure execution system may also initiate an infrastructure-based takeover. In certain environments, infrastructure-based sensors (e.g. RGB cameras, depth cameras, radar sensors, LiDAR sensors, etc.) may be available (e.g., roadside sensors that supervise traffic). If the reason for the breakdown is a sensor failure and sufficient infrastructure sensors are available, the countermeasure execution system might make use of infrastructure sensors and allow the infrastructure to take control of the impaired vehicle. As should be appreciated, the infrastructure may impose different behavior modes that depend on the available infrastructure sensors (e.g., a low driving speed) and may also adjust traffic patterns accordingly (e.g., illuminating a temporary lane closures sign, changing a traffic light to stop traffic from flowing through an intersection where the breakdown occurred, etc.). For this countermeasure, the countermeasure execution system may provide support to the infrastructure/edge-based controller by providing sensor data from any functioning sensors that remain on the vehicle.

As an alternative to the infrastructure taking over control of the impaired vehicle, the impaired vehicle might simply utilize the sensory data that might be available from the infrastructure sensors in order to override its failed sensor(s). In such a case, the automated driving system of the vehicle would remain in control of the vehicle, but it would utilize sensor data that is received from the infrastructure equipment in lieu of its faulty sensor data. At breakdown, the vehicle may report the sensory failure to an off-vehicle service (e.g., an edge- or cloud-based service) and request sensor support. The off-vehicle service may evaluate if sensor support is available that would mitigate the failed sensor and provide a safe solution (e.g. sufficient to reach a safe parking location beside a highway), and then the off-vehicle service may approve the request and start publishing the relevant sensor data to the vehicle. Given that the infrastructure sensor(s) may have a different perspective as compared to sensor(s) they are replacing, the infrastructure (or vehicle) may need to perform a coordinate conversion of the sensor data to the perspective of the vehicle and/or replaced sensor.

For example, if roadside LiDAR sensors are to replace the vehicle's faulty LiDAR, the infrastructure may localize the impaired vehicle, filter the relevant points (e.g. within a certain range to the vehicle), and then transform the points into the vehicle's coordinate system so that it properly represents the on-vehicle perspective of the faulty LiDAR sensor. In certain cases, raw sensor data might not be compatible with the automated driving software of the vehicle (e.g., a camera image taken from a building beside a road might not be processable into data that is useful for the vehicle's perspective). In such cases, a higher level of information could be exchanged (e.g., detected objects and associated trajectory information).

The breakdown detection system and the countermeasure execution system may also use a mobility-as-a-service (MaaS) connector that connects the breakdown detection to the countermeasure execution using a MaaS provider in order to execute additional types of countermeasures, especially when passengers are impacted. Typically, a MaaS connector may be available if the broken vehicle itself is part of a MaaS fleet, but as should be appreciated, a MaaS connector may also be used for a vehicle that is not part of a MaaS fleet. Once the MaaS connector has connected the MaaS provider, the MaaS provider may select potential countermeasures. One approach that the MaaS provider may use to select potential countermeasures is a lookup table that specifies which countermeasure action should be taken for a certain breakdown reason. As should be appreciated, the MaaS provider may have extensive historical data, and it may use a more sophisticated algorithm, such as an artificial intelligence-based model to identify the best countermeasure using information about the location of the breakdown, the location of other fleet vehicles, passenger input, passenger profile, safety estimation, time of day, weather, road/traffic condition, etc. The output of such an artificial intelligence-based model may then be an optimal countermeasure for each breakdown. The MaaS provider may also use crowd-sourced data to improve the artificial intelligence-based model. Additionally, the MaaS provider may input data from public authorities, including for example (custom) traffic regulations or information about traffic flow requirements.

A MaaS-connected system may provide additional information and requests for service using a MaaS application (app) on a passenger's computing device (e.g., a smartphone, tablet, etc.). To achieve a quality user experience, the MaaS application may provide the passenger with additional status information and countermeasure choices, such an updated time of arrival of assistance, potential other travel options from the current location (e.g., by switching to another MaaS vehicle that is nearby or could be summoned), etc. The MaaS provider may store a user profile that may be consulted when determining which specific dialogs, questions, and information to present/display. For example, if the MaaS provider determines that the passenger is a child, the dialogs, questions, and information may be very basic or may be re-routed as a message to a computing device of the child's parent. As should be appreciated, a human operator may take over the dialog by calling the passenger.

The MaaS provider might influence the passenger's selection of a countermeasure by providing, for example, monetary benefits for selecting a certain countermeasure over another. For example, if a breakdown could be repaired with a passenger action, the passenger might receive a monetary discount (e.g., on the next MaaS service) for performing the passenger repair as the countermeasure. As another example, the MaaS provider may give a discount if the passenger is required to wait for a countermeasure (e.g., waiting for a helping vehicle to arrive) or for the inconvenience of the countermeasure (e.g., the passenger must change to a different MaaS vehicle).

For MaaS vehicles that breakdown, different types of countermeasures may be available as compared to those discussed earlier. If the MaaS vehicle is associated with a MaaS provider that has a fleet of MaaS vehicles, another MaaS vehicle might be ordered to pick up the passenger(s) at the breakdown location. As should be appreciated, if the breakdown location is too dangerous for the passengers to directly change vehicles, the passengers might be ordered to move to a safe pickup location where the MaaS provider will send the replacement MaaS vehicle. If a breakdown location is too dangerous for passengers to leave the vehicle, the MaaS provider may request additional/multiple MaaS vehicles to protect the passengers during the change of vehicles by having the additional/multiple vehicles slowing down or stop at specific locations near the breakdown (e.g., to block dangerous traffic). In addition, the MaaS system may continuously inform the passengers about the waiting time, progress of countermeasures, and any actions that the passengers may need to take. In case of a severe breakdown, the MaaS provider might also adapt the planned route of the passenger so that the passengers reach their goal as soon as possible. After rerouting, the MaaS application may instruct the passengers, for example, to use an alternative transportation service/entity. If the breakdown of the MaaS vehicle is such that some form of movement of the MaaS vehicle is still possible (though possibly degraded because of the breakdown), the MaaS provider may direct the impaired MaaS vehicle to a transfer location so as to minimize the delay.

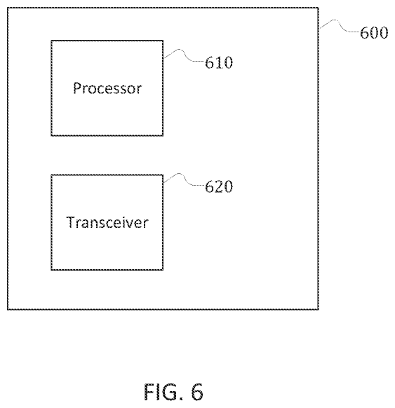

FIG. 6 is a schematic drawing illustrating a device 600 for providing and/or utilizing virtual towing assistance between a helping vehicle (towing vehicle) and an impaired vehicle (towed vehicle). The device 600 may include any of the features of the virtual towing systems described above, including, as examples, the virtual towing systems described with respect to FIG. 1, 2A, 2B, and 3-5. The virtual towing system of FIG. 6 may be implemented as a device, a method, and/or a computer readable medium that, when executed, performs the features of the safety systems described above. It should be understood that device 600 is only an example, and other configurations may be possible that include, for example, different components or additional components.

Device 600 includes a processor 610. In addition to or in combination with any of the features described in this or the following paragraphs, the processor 610 of device 600 is configured to receive a message indicating an offer from a helping vehicle to provide virtual towing services to an impaired vehicle. Processor 610 is also configured to activate a virtual towing mode based on acceptance of the offer, wherein the virtual towing mode includes the processor 610 further configured to receive waypoint information and speed information from the helping vehicle and control movements of the impaired vehicle based on the waypoint information and the speed information.

Furthermore, in addition to or in combination with any one of the features of this and/or the preceding paragraph with respect to device 600, processor 610 may be configured to generate a breakdown report that indicates an impaired operation of the impaired vehicle. Furthermore, in addition to or in combination with any one of the features of this and/or the preceding paragraph with respect to device 600, the message may be responsive to the breakdown report. Furthermore, in addition to or in combination with any one of the features of this and/or the preceding paragraph, the processor 610 configured to control movements of the impaired vehicle may include the processor 610 configured to plan an approach to a waypoint defined by the waypoint information and to maintain a target speed defined by the speed information. Furthermore, in addition to or in combination with any one of the features of this and/or the preceding paragraph with respect to device 600, the waypoint may include a previous waypoint location of the helping vehicle at a first time that is different from a target time for the impaired vehicle to reach the waypoint. Furthermore, in addition to or in combination with any one of the features of this and/or the preceding paragraph with respect to device 600, the waypoint may include a coordinate conversion of the previous waypoint location from a first coordinate system of the helping vehicle at the a first time to a second coordinate system of the impaired vehicle at the a second target time.

Furthermore, in addition to or in combination with any one of the features of this and/or the preceding two paragraphs, processor 610 may be further configured to transmit (e.g., via transmitter/transceiver 620) the breakdown report to a server (e.g. a cloud server) external to the impaired vehicle. Furthermore, in addition to or in combination with any one of the features of this and/or the preceding two paragraphs, processor 610 may be further configured to transmit (e.g., via transceiver 620) the breakdown report as a broadcast message on a shared communication channel. Furthermore, in addition to or in combination with any one of the features of this and/or the preceding two paragraphs, the virtual towing mode may further include the processor 610 configured to transmit (e.g., via transceiver 620) sensor data to the helping vehicle, wherein the sensor data includes information about an environment around the impaired vehicle. Furthermore, in addition to or in combination with any one of the features of this and/or the preceding two paragraphs with respect to device 600, the impaired operation of the impaired vehicle may include a failure of a perception system of an automated driving system of the impaired vehicle. Furthermore, in addition to or in combination with any one of the features of this and/or the preceding two paragraphs with respect to device 600, the automated driving system of the impaired vehicle may be operated by another processor that operates independently from the processor 610.

Furthermore, in addition to or in combination with any one of the features of this and/or the preceding three paragraphs with respect to device 600, the impaired vehicle may include an automated driving system, wherein the virtual towing mode includes the processor 610 further configured to control movements of the impaired vehicle based on the waypoint information and speed information in lieu of the automated driving system. Furthermore, in addition to or in combination with any one of the features of this and/or the preceding three paragraphs with respect to device 600, the helping vehicle may include a plurality of helping vehicles, and the offer to provide the virtual towing services may be a collective offer to provide the virtual towing services from the plurality of vehicles. Furthermore, in addition to or in combination with any one of the features of this and/or the preceding three paragraphs with respect to device 600, the plurality of helping vehicles may include a leader helping vehicle and a sensing helping vehicle, where the sensing helping vehicle may be configured to provide additional sensor data to the leader helping vehicle. Furthermore, in addition to or in combination with any one of the features of this and/or the preceding three paragraphs with respect to device 600, the helping vehicle may include at least one of an unmanned aerial vehicle, an automobile, an autonomous driving vehicle, and a partially autonomous driving vehicle.

Furthermore, in addition to or in combination with any one of the features of this and/or the preceding four paragraphs, the virtual towing mode may further include the processor 610 further configured to execute a stop maneuver if a distance between a current location of the impaired vehicle and the waypoint falls below a predetermined threshold or if the impaired vehicle fails to receive a communication confirmation from the helping vehicle within a predetermined time period. Furthermore, in addition to or in combination with any one of the features of this and/or the preceding four paragraphs with respect to device 600, the breakdown report may further include vehicle characteristics about the impaired vehicle and/or status information about an automated driving system of the impaired vehicle. Furthermore, in addition to or in combination with any one of the features of this and/or the preceding four paragraphs with respect to device 600, the waypoint information and/or the speed information may be further based on the vehicle characteristics. Furthermore, in addition to or in combination with any one of the features of this and/or the preceding four paragraphs with respect to device 600, the waypoint information and/or the speed information may be based on a transformation from a coordinate system of the helping vehicle to a coordinate system of the impaired vehicle. Furthermore, in addition to or in combination with any one of the features of this and/or the preceding four paragraphs with respect to device 600, the waypoint information and/or the speed information may be based on a joint safety assessment of the helping vehicle and of the impaired vehicle.

Furthermore, in addition to or in combination with any one of the features of this and/or the preceding five paragraphs with respect to device 600, the waypoint information may include a plurality of waypoints over a time period, wherein each waypoint of the plurality of waypoints is associated with a different time of the time period. Furthermore, in addition to or in combination with any one of the features of this and/or the preceding five paragraphs, the processor 610 may be further configured to generate a trajectory over the time period based on the plurality of waypoints, wherein the trajectory traverses fewer than all of waypoints. Furthermore, in addition to or in combination with any one of the features of this and/or the preceding five paragraphs with respect to device 600, the speed information may include a plurality of target speeds over a time period, wherein each target speed of the plurality of target speeds is associated with a different time of the time period. Furthermore, in addition to or in combination with any one of the features of this and/or the preceding five paragraphs with respect to device 600, the virtual towing services may include, in lieu of a physical connection between the impaired vehicle and the helping vehicle, a communication connection for receiving the waypoint information and the speed information from the helping vehicle. Furthermore, in addition to or in combination with any one of the features of this and/or the preceding five paragraphs with respect to device 600, the waypoint information may be based on a determined geographic location of the impaired vehicle.

In addition to or as an alternative to device 600 described above, device 600 includes a processor 610 configured to transmit a message indicating an offer to provide virtual towing services to the towed vehicle. In addition to or in combination with any of the features described in this or the following paragraphs, processor 610 is also configured to activate a virtual towing mode based on acceptance of the offer. In addition to or in combination with any of the features described in this or the following paragraphs, the virtual towing mode includes the processor 610 further configured to determine a pathway to a repair destination for the towing vehicle together with towed vehicle, determine a waypoint and a speed for the towing vehicle along the pathway based on a joint safety assessment of the towing vehicle and the towed vehicle, determine waypoint information and speed information for the towed vehicle based on a transformation of the waypoint and the speed from a coordinate system of the towing vehicle to a coordinate system of the towed vehicle, transmit the waypoint information and speed information to the towed vehicle, and control movements of the towing vehicle to travel toward the waypoint at the speed and according to the joint safety assessment.

Furthermore, in addition to or in combination with any one of the features of this and/or the preceding paragraph, processor 610 may be further configured to receive (e.g., via transceiver 620) a breakdown report that indicates impaired operation of an automated driving system of the towed vehicle. Furthermore, in addition to or in combination with any one of the features of this and/or the preceding paragraph with respect to device 600, the message may be responsive to the breakdown report. Furthermore, in addition to or in combination with any one of the features of this and/or the preceding paragraph with respect to device 600, the pathway may be further based on the breakdown report. Furthermore, in addition to or in combination with any one of the features of this and/or the preceding paragraph with respect to device 600, the joint safety assessment may include a safety evaluation of movements of the towed vehicle and the towing vehicle based on at least one of a safety envelope that encompasses at least dimensions of the towed vehicle and the towing vehicle; a weight of the towed vehicle and/or of the helping vehicle; traffic objects proximate to the towed vehicle and/or to the helping vehicle; and a traffic environment along the pathway to the repair destination.

Furthermore, in addition to or in combination with any one of the features of this and/or the preceding two paragraphs, processor 610 may be further configured to determine a owing position of the towing vehicle with respect to the towed vehicle, wherein the towing position is based on at least one of a breakdown report that indicates impaired operation of an automated driving system of the towed vehicle, a traffic situation around the towed vehicle, a road type where the towed vehicle is positioned, and a lane in which the towed vehicle is positioned. Furthermore, in addition to or in combination with any one of the features of this and/or the preceding two paragraphs with respect to device 600, the towing position may include a rear position located behind the towed vehicle, a front position located in front of the towed vehicle, a side position located beside the towed vehicle. Furthermore, in addition to or in combination with any one of the features of this and/or the preceding two paragraphs, processor 610 may be further configured in the virtual towing mode to receive vehicle sensor data from the towed vehicle, wherein processor 610 may be further configured to determine the joint safety assessment based on the towed vehicle sensor data.

Furthermore, in addition to or in combination with any one of the features of this and/or the preceding three paragraphs, processor 610 may be configured to accept the offer based on at least one of a current location of the towing vehicle, a breakdown location of the towed vehicle, a type of impairment of the towed vehicle; and a geographic distance between the towed vehicle and the towing vehicle. Furthermore, in addition to or in combination with any one of the features of this and/or the preceding three paragraphs, processor 610 may be further configured to receive (e.g., via transceiver 620) the breakdown report from the towed vehicle or a server (e.g. a cloud server) external to the towed vehicle. Furthermore, in addition to or in combination with any one of the features of this and/or the preceding three paragraphs, processor 610 may be further configured to receive (e.g., via transceiver 620) the breakdown report as a broadcast message on a shared communication channel. Furthermore, in addition to or in combination with any one of the features of this and/or the preceding three paragraphs with respect to device 600, the virtual towing mode may further include processor 610 configured to receive sensor data from the towed vehicle, wherein the sensor data includes information about an environment around the towed vehicle.

Furthermore, in addition to or in combination with any one of the features of this and/or the preceding four paragraphs with respect to device 600, the impaired operation of the towed vehicle may include a failure of a perception system of an automated driving system of the towed vehicle. Furthermore, in addition to or in combination with any one of the features of this and/or the preceding four paragraphs with respect to device 600, the towing vehicle may be configured in the virtual towing mode to coordinate with at least one other helping vehicle to provide virtual towing services. Furthermore, in addition to or in combination with any one of the features of this and/or the preceding four paragraphs with respect to device 600, the towing vehicle may include a leader vehicle and the at least one other vehicle includes a sensing vehicle, wherein the leader vehicle is configured to receive additional sensor data from the sensing vehicle. Furthermore, in addition to or in combination with any one of the features of this and/or the preceding four paragraphs with respect to device 600, the towing vehicle may include a sensing vehicle and the at least one other vehicle includes a leader vehicle, wherein the sensing vehicle is configured to transmit additional sensor data (e.g., via transceiver 620) to the leader vehicle.

Furthermore, in addition to or in combination with any one of the features of this and/or the preceding five paragraphs with respect to device 600, the towing vehicle may include at least one of an unmanned aerial vehicle, an automobile, an autonomous driving vehicle, and a partially autonomous driving vehicle. Furthermore, in addition to or in combination with any one of the features of this and/or the preceding five paragraphs with respect to device 600, the breakdown report may further include vehicle characteristics about the towed vehicle and/or status information about an automated driving system of the towed vehicle. Furthermore, in addition to or in combination with any one of the features of this and/or the preceding five paragraphs with respect to device 600, the joint safety assessment may be further based on the vehicle characteristics. Furthermore, in addition to or in combination with any one of the features of this and/or the preceding five paragraphs with respect to device 600, the waypoint information may include a plurality of target waypoints over a time period, wherein each target waypoint of the plurality of target waypoints is associated with a different time of the time period.

Furthermore, in addition to or in combination with any one of the features of this and/or the preceding six paragraphs with respect to device 600, the speed information may include a plurality of target speeds over a time period, wherein each target speed of the plurality of target speeds is associated with a different time of the time period. Furthermore, in addition to or in combination with any one of the features of this and/or the preceding six paragraphs with respect to device 600, the virtual towing services may include, in lieu of a physical connection between the towing vehicle and the towed vehicle, a communication connection for transmitting the waypoint information and the speed information to the towed vehicle. Furthermore, in addition to or in combination with any one of the features of this and/or the preceding six paragraphs with respect to device 600, the waypoint information may be based on a determined geographic location of the towed vehicle.

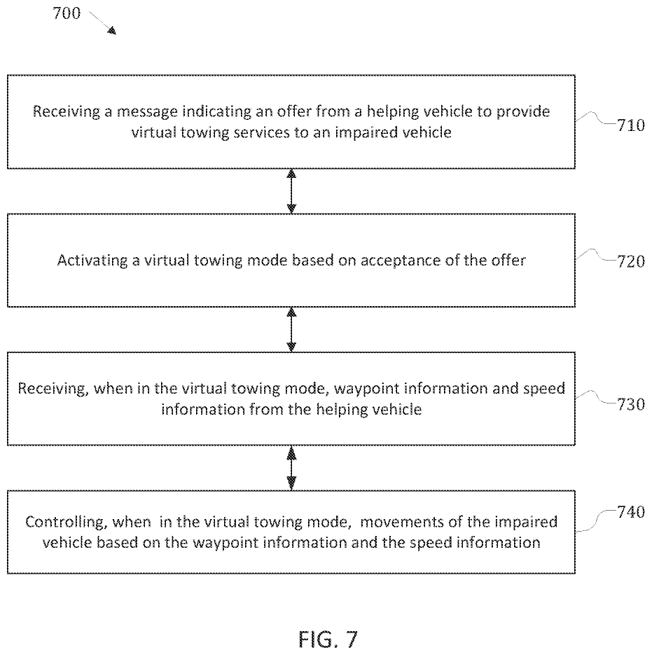

FIG. 7 depicts a schematic flow diagram of a method 700 providing and/or utilizing virtual towing assistance between a helping vehicle and an impaired vehicle. Method 700 may implement any of the features of the virtual towing systems described above with respect to, as examples, FIGS. 1, 2A, 2B, and 3-6.

Method 700 includes, in 710, receiving a message indicating an offer from a helping vehicle to provide virtual towing services to an impaired vehicle. Method 700 also includes, in 720, activating a virtual towing mode based on acceptance of the offer. Method 700 also includes, when in the virtual towing mode, in 730, receiving waypoint information and speed information from the helping vehicle. Method 700 also includes, when in the virtual towing mode, in 740, controlling movements of the impaired vehicle based on the waypoint information and the speed information.

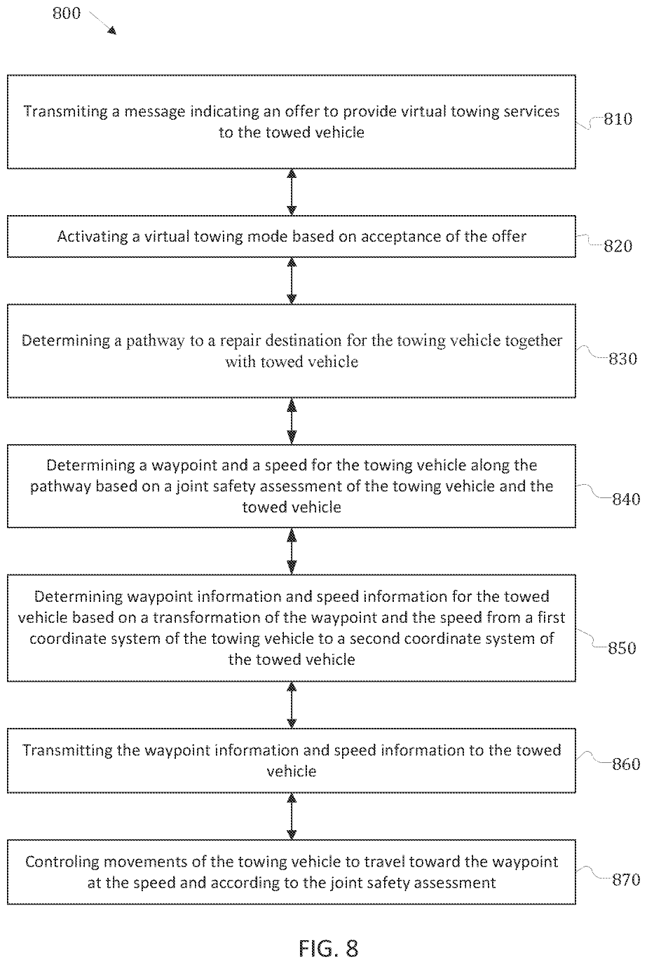

FIG. 8 depicts a schematic flow diagram of a method 800 providing and/or utilizing virtual towing assistance between a helping vehicle and an impaired vehicle. Method 800 may implement any of the features of the virtual towing systems described above with respect to, as examples, FIGS. 1, 2A, 2B, and 3-7.

Method 800 includes, in 810, transmitting a message indicating an offer to provide virtual towing services to the towed vehicle. Method 800 also includes, in 820, activating a virtual towing mode based on acceptance of the offer. Method 800 also includes, when in the virtual towing mode, in 830, determining a pathway to a repair destination for the towing vehicle together with towed vehicle. Method 800 also includes, when in the virtual towing mode, in 840, determining a waypoint and a speed for the towing vehicle along the pathway based on a joint safety assessment of the towing vehicle and the towed vehicle. Method 800 also includes, when in the virtual towing mode, in 850, determining waypoint information and speed information for the towed vehicle based on a transformation of the waypoint and the speed from a first coordinate system of the towing vehicle to a second coordinate system of the towed vehicle. Method 800 also includes, when in the virtual towing mode, in 860, transmitting the waypoint information and speed information to the towed vehicle. Method 800 also includes, when in the virtual towing mode, in 870, controlling movements of the towing vehicle to travel toward the waypoint at the speed and according to the joint safety assessment.

In the following, various examples are provided that may include one or more features of the virtual towing systems described above with reference to, as examples, FIGS. 1, 2A, 2B, and 3-8. It may be intended that aspects described in relation to the devices may apply also to the described method(s), and vice versa.

Example 1 is a device including a processor configured to receive a message indicating an offer from a helping vehicle to provide virtual towing services to an impaired vehicle. The processor is also configured to activate a virtual towing mode based on acceptance of the offer, wherein the virtual towing mode includes the processor further configured to receive waypoint information and speed information from the helping vehicle and control movements of the impaired vehicle based on the waypoint information and the speed information.

Example 2 is the device of example 1, wherein the processor is configured to generate a breakdown report that indicates an impaired operation of the impaired vehicle.

Example 3 is the device of example 2, wherein the message is responsive to the breakdown report.

Example 4 is the device of any one of examples 1 to 3, wherein the processor configured to control movements of the impaired vehicle includes the processor configured to plan an approach to a waypoint defined by the waypoint information and to maintain a target speed defined by the speed information.

Example 5 is the device of example 4, wherein the waypoint includes a previous location of the helping vehicle.

Example 6 is the device of example 5, wherein the waypoint includes a coordinate conversion of the previous location from a first coordinate system of the helping vehicle at a first time to a second coordinate system of the impaired vehicle at a second time.

Example 7 is the device of example 2 optionally combined with any of examples 3 to 6, wherein the processor is further configured to transmit (e.g., via a transmitter/transceiver) the breakdown report to a server (e.g. a cloud server) external to the impaired vehicle.

Example 8 is the device of example 2 optionally combined with any of examples 3 to 7, wherein the processor is further configured to transmit (e.g., via a transmitter/transceiver) the breakdown report as a broadcast message on a shared communication channel.

Example 9 is the device of any one of examples 1 to 8, wherein the virtual towing mode further includes the processor configured to transmit sensor data to the helping vehicle, wherein the sensor data includes information about an environment around the impaired vehicle.

Example 10 is the device of example 2 optionally combined with any of examples 3 to 9, wherein the impaired operation of the impaired vehicle includes a failure of an automated driving system of the impaired vehicle.

Example 11 is the device of example 10, wherein the failure of the automated driving system includes a perception system failure, a communication system failure, and/or a planning system failure.

Example 12 is the device of any one of examples 1 to 11, wherein the automated driving system of the impaired vehicle is operated by an other processor that operates independently from the processor.

Example 13 is the device of any one of examples 1 to 12, wherein the impaired vehicle includes an automated driving system, wherein the virtual towing mode includes the processor further configured to control movements of the impaired vehicle based on the waypoint information and speed information in lieu of the automated driving system.

Example 14 is the device of any one of examples 1 to 13, wherein the helping vehicle includes a plurality of helping vehicles, and the offer to provide the virtual towing services is a collective offer to provide the virtual towing services from the plurality of vehicles.

Example 15 is the device of example 14, wherein the plurality of helping vehicles includes a leader helping vehicle and a sensing helping vehicle, where the sensing helping vehicle is configured to provide additional sensor data to the leader helping vehicle.

Example 16 is the device of any one of examples 1 to 15, wherein the helping vehicle includes at least one of: an unmanned aerial vehicle, an automobile, an autonomous driving vehicle, and a partially autonomous driving vehicle.

Example 17 is the device of any one of examples 1 to 16, wherein the virtual towing mode further includes the processor further configured to execute a stop maneuver if a distance between a current location of the impaired vehicle and the waypoint falls below a predetermined threshold or if the impaired vehicle fails to receive a communication confirmation from the helping vehicle within a predetermined time period.

Example 18 is the device of example 2 optionally combined with any of examples 3 to 17, wherein the breakdown report further includes vehicle characteristics about the impaired vehicle and/or status information about an automated driving system of the impaired vehicle.

Example 19 is the device of example 18, wherein the waypoint information and/or the speed information is further based on the vehicle characteristics.

Example 20 is the device of any one of examples 1 to 19, wherein the waypoint information and/or the speed information is based on a transformation from a coordinate system of the helping vehicle to a coordinate system of the impaired vehicle.

Example 21 is the device of any one of examples 1 to 20, wherein the waypoint information and/or the speed information is based on a joint safety assessment of the helping vehicle and of the impaired vehicle.

Example 22 is the device of any one of examples 1 to 21, wherein the waypoint information includes a plurality of waypoints over a time period, wherein each waypoint of the plurality of waypoints is associated with a different time of the time period.

Example 23 is the device of example 22, wherein the processor is further configured to generate a trajectory over the time period based on the plurality of waypoints, wherein the trajectory traverses fewer than all of waypoints.

Example 24 is the device of any one of examples 1 to 23, wherein the speed information includes a plurality of target speeds over a time period, wherein each target speed of the plurality of target speeds is associated with a different time of the time period.

Example 25 is the device of any one of examples 1 to 24, wherein the virtual towing services include, in lieu of a physical connection between the impaired vehicle and the helping vehicle, a communication connection for receiving the waypoint information and the speed information from the helping vehicle.

Example 26 is the device of any one of examples 1 to 25, wherein the waypoint information is based on a determined geographic location of the impaired vehicle.

Example 27 is a device for providing virtual towing services from a towing vehicle to a towed vehicle, the device including a processor configured to transmit a message indicating an offer to provide virtual towing services to the towed vehicle. The processor is also configured to activate a virtual towing mode based on acceptance of the offer. The virtual towing mode includes the processor further configured to determine a pathway to a repair destination for the towing vehicle together with towed vehicle, determine a waypoint and a speed for the towing vehicle along the pathway based on a joint safety assessment of the towing vehicle and the towed vehicle, determine waypoint information and speed information for the towed vehicle based on a transformation of the waypoint and the speed from a coordinate system of the towing vehicle to a coordinate system of the towed vehicle, transmit the waypoint information and speed information to the towed vehicle, and control movements of the towing vehicle to travel toward the waypoint at the speed and according to the joint safety assessment.

Example 28 is the device of example 27, wherein the processor is further configured to receive a breakdown report that indicates impaired operation of an automated driving system of the towed vehicle.

Example 29 is the device of example 28, wherein the message is responsive to the breakdown report.

Example 30. The device of either one of examples 28 or 29, wherein the pathway is further based on the breakdown report.

Example 31 is the device of any one of examples 27 to 30, wherein the joint safety assessment includes a safety evaluation of movements of the towed vehicle and the towing vehicle based on at least one of: a safety envelope that encompasses at least dimensions of the towed vehicle and the towing vehicle; a weight of the towed vehicle and/or of the helping vehicle; traffic objects proximate to the towed vehicle and/or to the helping vehicle; and a traffic environment along the pathway to the repair destination.

Example 32 is the device of either of examples 27 or 31, wherein the processor is further configured to determine a towing position of the towing vehicle with respect to the towed vehicle, wherein the towing position is based on at least one of: a breakdown report that indicates impaired operation of an automated driving system of the towed vehicle, a traffic situation around the towed vehicle, a road type where the towed vehicle is positioned, and a lane in which the towed vehicle is positioned.

Example 33 is the device of example 32, wherein the towing position includes a rear position located behind the towed vehicle, a front position located in front of the towed vehicle, a side position located beside the towed vehicle.

Example 34 is the device of any one of examples 27 to 33, wherein the processor is further configured in the virtual towing mode to receive vehicle sensor data from the towed vehicle, wherein the processor is further configured to determine the joint safety assessment based on the towed vehicle sensor data.

Example 35 is the device of any one of examples 27 to 34, wherein the processor is configured to accept the offer based on at least one of: a current location of the towing vehicle, a breakdown location of the towed vehicle, a type of impairment of the towed vehicle; and a geographic distance between the towed vehicle and the towing vehicle.

Example 36 is the device of example 28 optionally combined with any of examples 29 to 35, wherein the processor is further configured to receive (e.g., via a receiver/transceiver) the breakdown report from the towed vehicle or a server (e.g. a cloud server) external to the towed vehicle.

Example 37 is the device of claim 28 optionally combined with any of examples 29 to 36, wherein the processor is further configured to receive (e.g., via a receiver/transceiver) the breakdown report as a broadcast message on a shared communication channel.

Example 38 is the device of any one of examples 27 to 37, wherein the virtual towing mode further includes the processor configured to receive sensor data from the towed vehicle, wherein the sensor data includes information about an environment around the towed vehicle.

Example 39 is the device of example 28 optionally combined with any of examples 29 to 38, wherein the impaired operation of the towed vehicle includes a failure of an automated driving system of the towed vehicle.

Example 40 is the device of example 39, wherein the failure of the automated driving system includes a perception system failure, a communication system failure, and/or a planning system failure.

Example 41 is the device of any one of examples 27 to 40, wherein the towing vehicle is configured in the virtual towing mode to coordinate with at least one other helping vehicle to provide virtual towing services

Example 42 is the device of example 41, wherein the towing vehicle includes a leader vehicle and the at least one other vehicle includes a sensing vehicle, wherein the leader vehicle is configured to receive additional sensor data from the sensing vehicle.

Example 43 is the device of example 41, wherein the towing vehicle includes a sensing vehicle and the at least one other vehicle includes a leader vehicle, wherein the sensing vehicle is configured to transmit additional sensor data to the leader vehicle.

Example 44 is the device of any one of examples 27 to 43, wherein the towing vehicle includes at least one of: an unmanned aerial vehicle, an automobile, an autonomous driving vehicle, and a partially autonomous driving vehicle.

Example 45 is the device of any one of examples 28 optionally combined with any of claims 29 to 44, wherein the breakdown report further includes vehicle characteristics about the towed vehicle and/or status information about an automated driving system of the towed vehicle.

Example 46 is the device of example 45, wherein the joint safety assessment is further based on the vehicle characteristics.

Example 47 is the device of any one of examples 27 to 46, wherein the waypoint information includes a plurality of target waypoints over a time period, wherein each target waypoint of the plurality of target waypoints is associated with a different time of the time period.

Example 48 is the device of any one of examples 27 to 47, wherein the speed information includes a plurality of target speeds over a time period, wherein each target speed of the plurality of target speeds is associated with a different time of the time period.

Example 49 is the device of any one of examples 27 to 48, wherein the virtual towing services include, in lieu of a physical connection between the towing vehicle and the towed vehicle, a communication connection for transmitting the waypoint information and the speed information to the towed vehicle.

Example 50 is the device of any one of examples 27 to 49, wherein the waypoint information is based on a determined geographic location of the towed vehicle.

Example 51 is a method including receiving a message indicating an offer from a helping vehicle to provide virtual towing services to an impaired vehicle. The method also includes activating a virtual towing mode based on acceptance of the offer, wherein the virtual towing mode includes the method further including receiving waypoint information and speed information from the helping vehicle and controlling movements of the impaired vehicle based on the waypoint information and the speed information.

Example 52 is the method of example 51, the method further including generating a breakdown report that indicates an impaired operation of the impaired vehicle.

Example 53 is the method of example 52, wherein the message is responsive to the breakdown report.

Example 54 is the method of any one of examples 51 to 53, wherein the controlling movements of the impaired vehicle includes planning an approach to a waypoint defined by the waypoint information and to maintain a target speed defined by the speed information.

Example 55 is the method of example 54, wherein the waypoint includes a previous location of the helping vehicle.

Example 56 is the method of example 55, wherein the waypoint includes a coordinate conversion of the previous location from a first coordinate system of the helping vehicle at a first time to a second coordinate system of the impaired vehicle at a second time.

Example 57 is the method of example 52 optionally combined with any of examples 53 to 56, the method further including transmitting (e.g., via a transmitter/transceiver) the breakdown report to a server (e.g. a cloud server) external to the impaired vehicle.

Example 58 is the method of example 52 optionally combined with any of examples 53 to 57, the method further including transmitting (e.g., via a transmitter/transceiver) the breakdown report as a broadcast message on a shared communication channel.

Example 59 is the method of any one of examples 51 to 58, wherein the method further includes, if in the virtual towing mode, transmitting sensor data to the helping vehicle, wherein the sensor data includes information about an environment around the impaired vehicle.

Example 60 is the method of example 52 optionally combined with any of examples 53 to 59, wherein the impaired operation of the impaired vehicle includes a failure of an automated driving system of the impaired vehicle.

Example 61 is the method of example 60, wherein the failure of the automated driving system includes a perception system failure, a communication system failure, and/or a planning system failure.

Example 62 is the method of any one of examples 51 to 61, the method further including, if in the virtual towing mode, controlling movements of the impaired vehicle based on the waypoint information and speed information in lieu of an automated driving system of the impaired vehicle.

Example 63 is the method of any one of examples 51 to 62, wherein the helping vehicle includes a plurality of helping vehicles, and the offer to provide the virtual towing services is a collective offer to provide the virtual towing services from the plurality of vehicles.

Example 64 is the method of example 63, wherein the plurality of helping vehicles includes a leader helping vehicle and a sensing helping vehicle, where the sensing helping vehicle provides additional sensor data to the leader helping vehicle.

Example 65 is the method of any one of examples 51 to 64, wherein the helping vehicle includes at least one of: an unmanned aerial vehicle, an automobile, an autonomous driving vehicle, and a partially autonomous driving vehicle.

Example 66 is the method of any one of examples 51 to 65, the method further including, if in the virtual towing mode, executing a stop maneuver if a distance between a current location of the impaired vehicle and the waypoint falls below a predetermined threshold or if the impaired vehicle fails to receive a communication confirmation from the helping vehicle within a predetermined time period.

Example 67 is the method of example 52 optionally combined with any of examples 53 to 66, wherein the breakdown report further includes vehicle characteristics about the impaired vehicle and/or status information about an automated driving system of the impaired vehicle.

Example 68 is the method of example 67, wherein the waypoint information and/or the speed information is further based on the vehicle characteristics.

Example 69 is the method of any one of examples 51 to 68, wherein the waypoint information and/or the speed information is based on a transformation from a coordinate system of the helping vehicle to a coordinate system of the impaired vehicle.

Example 70 is the method of any one of examples 51 to 69, wherein the waypoint information and/or the speed information is based on a joint safety assessment of the helping vehicle and of the impaired vehicle.

Example 71 is the method of any one of examples 51 to 70, wherein the waypoint information includes a plurality of waypoints over a time period, wherein each waypoint of the plurality of waypoints is associated with a different time of the time period.

Example 72 is the method of example 71, the method further including generating a trajectory over the time period based on the plurality of waypoints, wherein the trajectory traverses fewer than all of waypoints.

Example 73 is the method of any one of examples 51 to 72, wherein the speed information includes a plurality of target speeds over a time period, wherein each target speed of the plurality of target speeds is associated with a different time of the time period.

Example 74 is the method of any one of examples 51 to 73, wherein the virtual towing services include, in lieu of a physical connection between the impaired vehicle and the helping vehicle, a communication connection for receiving the waypoint information and the speed information from the helping vehicle.

Example 75 is the method of any one of examples 51 to 74, wherein the waypoint information is based on a determined geographic location of the impaired vehicle.

Example 76 is a method for providing virtual towing services from a towing vehicle to a towed vehicle, the method including transmitting a message indicating an offer to provide virtual towing services to the towed vehicle. Method also includes activating a virtual towing mode based on acceptance of the offer. In the virtual towing mode, the method further includes determining a pathway to a repair destination for the towing vehicle together with towed vehicle, determining a waypoint and a speed for the towing vehicle along the pathway based on a joint safety assessment of the towing vehicle and the towed vehicle, determining waypoint information and speed information for the towed vehicle based on a transformation of the waypoint and the speed from a coordinate system of the towing vehicle to a coordinate system of the towed vehicle, transmitting the waypoint information and speed information to the towed vehicle, and controlling movements of the towing vehicle to travel toward the waypoint at the speed and according to the joint safety assessment.

Example 77 is the method of example 76, the method further including receiving a breakdown report that indicates impaired operation of an automated driving system of the towed vehicle.

Example 78 is the method of example 77, wherein the message is responsive to the breakdown report.

Example 79. The method of either one of examples 77 or 78, wherein the pathway is further based on the breakdown report.

Example 80 is the method of any one of examples 76 to 79, wherein the joint safety assessment includes a safety evaluation of movements of the towed vehicle and the towing vehicle based on at least one of: a safety envelope that encompasses at least dimensions of the towed vehicle and the towing vehicle; a weight of the towed vehicle and/or of the helping vehicle; traffic objects proximate to the towed vehicle and/or to the helping vehicle; and a traffic environment along the pathway to the repair destination.

Example 81 is the method of either of examples 76 or 80, the method further including determining a towing position of the towing vehicle with respect to the towed vehicle, wherein the towing position is based on at least one of: a breakdown report that indicates impaired operation of an automated driving system of the towed vehicle, a traffic situation around the towed vehicle, a road type where the towed vehicle is positioned, and a lane in which the towed vehicle is positioned.

Example 82 is the method of example 81, wherein the towing position includes a rear position located behind the towed vehicle, a front position located in front of the towed vehicle, a side position located beside the towed vehicle.

Example 83 is the method of any one of examples 76 to 82, the method further including, if in the virtual towing mode, receiving vehicle sensor data from the towed vehicle and determining the joint safety assessment based on the towed vehicle sensor data.

Example 84 is the method of any one of examples 76 to 83, the method further including accepting the offer based on at least one of: a current location of the towing vehicle, a breakdown location of the towed vehicle, a type of impairment of the towed vehicle; and a geographic distance between the towed vehicle and the towing vehicle.

Example 85 is the method of example 77 optionally combined with any of examples 78 to 84, the method further including receiving (e.g., via a receiver/transceiver) the breakdown report from the towed vehicle or a server (e.g. a cloud server) external to the towed vehicle.

Example 86 is the method of claim 77 optionally combined with any of examples 78 to 85, the method further including receiving (e.g., via a receiver/transceiver) the breakdown report as a broadcast message on a shared communication channel.

Example 87 is the method of any one of examples 76 to 86, the method further including, if in the virtual towing mode, receiving sensor data from the towed vehicle, wherein the sensor data includes information about an environment around the towed vehicle.

Example 88 is the method of example 77 optionally combined with any of examples 78 to 87, wherein the impaired operation of the towed vehicle includes a failure of an automated driving system of the towed vehicle.

Example 89 is the method of example 88, wherein the failure of the automated driving system includes a perception system failure, a communication system failure, and/or a planning system failure.

Example 90 is the method of any one of examples 76 to 89, wherein the towing vehicle is configured in the virtual towing mode to coordinate with at least one other helping vehicle to provide virtual towing services

Example 91 is the method of example 90, wherein the towing vehicle includes a leader vehicle and the at least one other vehicle includes a sensing vehicle, wherein the leader vehicle receives additional sensor data from the sensing vehicle.

Example 92 is the method of example 90, wherein the towing vehicle includes a sensing vehicle and the at least one other vehicle includes a leader vehicle, wherein the sensing vehicle transmits additional sensor data to the leader vehicle.

Example 93 is the method of any one of examples 76 to 92, wherein the towing vehicle includes at least one of: an unmanned aerial vehicle, an automobile, an autonomous driving vehicle, and a partially autonomous driving vehicle.

Example 94 is the method of any one of examples 77 optionally combined with any of claims 78 to 93, wherein the breakdown report further includes vehicle characteristics about the towed vehicle and/or status information about an automated driving system of the towed vehicle.

Example 95 is the method of example 94, wherein the joint safety assessment is further based on the vehicle characteristics.

Example 96 is the method of any one of examples 76 to 95, wherein the waypoint information includes a plurality of target waypoints over a time period, wherein each target waypoint of the plurality of target waypoints is associated with a different time of the time period.

Example 97 is the method of any one of examples 76 to 96, wherein the speed information includes a plurality of target speeds over a time period, wherein each target speed of the plurality of target speeds is associated with a different time of the time period.

Example 98 is the method of any one of examples 76 to 97, wherein the virtual towing services include, in lieu of a physical connection between the towing vehicle and the towed vehicle, a communication connection for transmitting the waypoint information and the speed information to the towed vehicle.

Example 99 is the method of any one of examples 76 to 98, wherein the waypoint information is based on a determined geographic location of the towed vehicle.

Example 100 is a device including a means for receiving a message indicating an offer from a helping vehicle to provide virtual towing services to an impaired vehicle. The device further includes a means for activating a virtual towing mode based on acceptance of the offer, wherein the virtual towing mode includes a means for receiving waypoint information and speed information from the helping vehicle and a means for controlling movements of the impaired vehicle based on the waypoint information and the speed information.

Example 101 is the device of example 100, the device further including a means for generating a breakdown report that indicates an impaired operation of the impaired vehicle.

Example 102 is the device of example 101, wherein the message is responsive to the breakdown report.

Example 103 is the device of any one of examples 100 to 102, wherein the means for controlling movements of the impaired vehicle includes a means for planning an approach to a waypoint defined by the waypoint information and to maintain a target speed defined by the speed information.

Example 104 is the device of example 103, wherein the waypoint includes a previous location of the helping vehicle.

Example 105 is the device of example 104, wherein the waypoint includes a coordinate conversion of the previous location from a first coordinate system of the helping vehicle at a first time to a second coordinate system of the impaired vehicle at a second time.

Example 106 is the device of example 101 optionally combined with any of examples 102 to 105, the device further including a means for transmitting (e.g., via a transmitter/transceiver) the breakdown report to a data processing means (e.g. a cloud server) external to the impaired vehicle.

Example 107 is the device of example 101 optionally combined with any of examples 102 to 106, the device further including a means for transmitting (e.g., via a transmitter/transceiver) the breakdown report as a broadcast message on a shared communication channel.

Example 108 is the device of any one of examples 100 to 107, wherein the virtual towing mode further includes a means for transmitting sensor data to the helping vehicle, wherein the sensor data includes information about an environment around the impaired vehicle.

Example 109 is the device of example 101 optionally combined with any of examples 102 to 108, wherein the impaired operation of the impaired vehicle includes a failure of an automated driving system of the impaired vehicle.

Example 110 is the device of example 109, wherein the failure of the automated driving system includes a perception system failure, a communication system failure, and/or a planning system failure.

Example 111 is the device of any one of examples 100 to 110, wherein the automated driving system of the impaired vehicle is operated by a processing means that operates independently from a second processing means of the impaired vehicle.

Example 112 is the device of any one of examples 100 to 111, wherein the impaired vehicle includes an automated driving system, wherein the virtual towing mode includes a means for controlling movements of the impaired vehicle based on the waypoint information and speed information in lieu of the automated driving system.

Example 113 is the device of any one of examples 100 to 112, wherein the helping vehicle includes a plurality of helping vehicles, and the offer to provide the virtual towing services is a collective offer to provide the virtual towing services from the plurality of vehicles.

Example 114 is the device of example 113, wherein the plurality of helping vehicles includes a leader helping vehicle and a sensing helping vehicle, where the sensing helping vehicle is configured to provide additional sensor data to the leader helping vehicle.

Example 115 is the device of any one of examples 100 to 114, wherein the helping vehicle includes at least one of: an unmanned aerial vehicle, an automobile, an autonomous driving vehicle, and a partially autonomous driving vehicle.

Example 116 is the device of any one of examples 100 to 115, wherein the virtual towing mode further includes the processor further configured to execute a stop maneuver if a distance between a current location of the impaired vehicle and the waypoint falls below a predetermined threshold or if the impaired vehicle fails to receive a communication confirmation from the helping vehicle within a predetermined time period.

Example 117 is the device of example 101 optionally combined with any of examples 102 to 116, wherein the breakdown report further includes vehicle characteristics about the impaired vehicle and/or status information about an automated driving system of the impaired vehicle.

Example 118 is the device of example 117, wherein the waypoint information and/or the speed information is further based on the vehicle characteristics.

Example 119 is the device of any one of examples 100 to 118, wherein the waypoint information and/or the speed information is based on a transformation from a coordinate system of the helping vehicle to a coordinate system of the impaired vehicle.

Example 120 is the device of any one of examples 100 to 119, wherein the waypoint information and/or the speed information is based on a joint safety assessment of the helping vehicle and of the impaired vehicle.

Example 121 is the device of any one of examples 100 to 120, wherein the waypoint information includes a plurality of waypoints over a time period, wherein each waypoint of the plurality of waypoints is associated with a different time of the time period.

Example 122 is the device of example 121, the device further including a means for generating a trajectory over the time period based on the plurality of waypoints, wherein the trajectory traverses fewer than all of waypoints.

Example 123 is the device of any one of examples 100 to 122, wherein the speed information includes a plurality of target speeds over a time period, wherein each target speed of the plurality of target speeds is associated with a different time of the time period.

Example 124 is the device of any one of examples 100 to 123, wherein the virtual towing services include, in lieu of a physical connection between the impaired vehicle and the helping vehicle, a communication connection for receiving the waypoint information and the speed information from the helping vehicle.

Example 125 is the device of any one of examples 100 to 124, wherein the waypoint information is based on a determined geographic location of the impaired vehicle.

Example 126 is a device for providing virtual towing services from a towing vehicle to a towed vehicle, the device including a means for transmitting a message indicating an offer to provide virtual towing services to the towed vehicle. The device also includes a means for activating a virtual towing mode based on acceptance of the offer. The virtual towing mode includes a means for determining a pathway to a repair destination for the towing vehicle together with towed vehicle, a means for determining a waypoint and a speed for the towing vehicle along the pathway based on a joint safety assessment of the towing vehicle and the towed vehicle, a means for determining waypoint information and speed information for the towed vehicle based on a transformation of the waypoint and the speed from a coordinate system of the towing vehicle to a coordinate system of the towed vehicle, a means for transmitting the waypoint information and speed information to the towed vehicle, and a means for controlling movements of the towing vehicle to travel toward the waypoint at the speed and according to the joint safety assessment.

Example 127 is the device of example 126, the device further includes a means for receiving a breakdown report that indicates impaired operation of an automated driving system of the towed vehicle.

Example 128 is the device of example 127, wherein the message is responsive to the breakdown report.

Example 129. The device of either one of examples 127 or 128, wherein the pathway is further based on the breakdown report.

Example 130 is the device of any one of examples 126 to 129, wherein the joint safety assessment includes a safety evaluation of movements of the towed vehicle and the towing vehicle based on at least one of: a safety envelope that encompasses at least dimensions of the towed vehicle and the towing vehicle; a weight of the towed vehicle and/or of the helping vehicle; traffic objects proximate to the towed vehicle and/or to the helping vehicle; and a traffic environment along the pathway to the repair destination.

Example 131 is the device of either of examples 126 or 130, the device further includes a means for determining a towing position of the towing vehicle with respect to the towed vehicle, wherein the towing position is based on at least one of: a breakdown report that indicates impaired operation of an automated driving system of the towed vehicle, a traffic situation around the towed vehicle, a road type where the towed vehicle is positioned, and a lane in which the towed vehicle is positioned.

Example 132 is the device of example 131, wherein the towing position includes a rear position located behind the towed vehicle, a front position located in front of the towed vehicle, a side position located beside the towed vehicle.

Example 133 is the device of any one of examples 126 to 132, wherein the virtual towing mode further includes a means for receiving vehicle sensor data from the towed vehicle and a means for determining the joint safety assessment based on the towed vehicle sensor data.

Example 134 is the device of any one of examples 126 to 133, the device further includes a means for accepting the offer based on at least one of: a current location of the towing vehicle, a breakdown location of the towed vehicle, a type of impairment of the towed vehicle; and a geographic distance between the towed vehicle and the towing vehicle.

Example 135 is the device of example 127 optionally combined with any of examples 128 to 134, the device further includes a means for receiving (e.g., via a receiver/transceiver) the breakdown report from the towed vehicle or a data computing means (e.g. a cloud server) external to the towed vehicle.

Example 136 is the device of claim 127 optionally combined with any of examples 128 to 135, the device further includes a means for receiving (e.g., via a receiver/transceiver) the breakdown report as a broadcast message on a shared communication channel.

Example 137 is the device of any one of examples 126 to 136, wherein the virtual towing mode further includes a means for receiving sensor data from the towed vehicle, wherein the sensor data includes information about an environment around the towed vehicle.

Example 138 is the device of example 127 optionally combined with any of examples 128 to 137, wherein the impaired operation of the towed vehicle includes a failure of an automated driving system of the towed vehicle.

Example 139 is the device of example 138, wherein the failure of the automated driving system includes a perception system failure, a communication system failure, and/or a planning system failure.

Example 140 is the device of any one of examples 126 to 139, wherein the towing vehicle is configured in the virtual towing mode to coordinate with at least one other helping vehicle to provide virtual towing services

Example 141 is the device of example 140, wherein the towing vehicle includes a leader vehicle and the at least one other vehicle includes a sensing vehicle, wherein the leader vehicle includes a means for receive additional sensor data from the sensing vehicle.

Example 142 is the device of example 140, wherein the towing vehicle includes a sensing vehicle and the at least one other vehicle includes a leader vehicle, wherein the sensing vehicle includes a means for transmitting additional sensor data to the leader vehicle.

Example 143 is the device of any one of examples 126 to 142, wherein the towing vehicle includes at least one of: an unmanned aerial vehicle, an automobile, an autonomous driving vehicle, and a partially autonomous driving vehicle.

Example 144 is the device of any one of examples 127 optionally combined with any of claims 128 to 143, wherein the breakdown report further includes vehicle characteristics about the towed vehicle and/or status information about an automated driving system of the towed vehicle.

Example 145 is the device of example 144, wherein the joint safety assessment is further based on the vehicle characteristics.

Example 146 is the device of any one of examples 126 to 145, wherein the waypoint information includes a plurality of target waypoints over a time period, wherein each target waypoint of the plurality of target waypoints is associated with a different time of the time period.

Example 147 is the device of any one of examples 126 to 146, wherein the speed information includes a plurality of target speeds over a time period, wherein each target speed of the plurality of target speeds is associated with a different time of the time period.

Example 148 is the device of any one of examples 126 to 147, wherein the virtual towing services include, in lieu of a physical connection between the towing vehicle and the towed vehicle, a means for transmitting over a communication connection the waypoint information and the speed information to the towed vehicle.

Example 149 is the device of any one of examples 126 to 148, wherein the waypoint information is based on a determined geographic location of the towed vehicle.

Example 150 is a non-transitory computer-readable medium that includes instructions which, if executed, cause one or more processors to receive a message indicating an offer from a helping vehicle to provide virtual towing services to an impaired vehicle. The instructions also cause the one or more processors to activate a virtual towing mode based on acceptance of the offer, wherein when in the virtual towing mode, the instructions also cause the one or more processors to receive waypoint information and speed information from the helping vehicle and control movements of the impaired vehicle based on the waypoint information and the speed information.

Example 151 is the non-transitory computer-readable medium of example 150, wherein the instructions also cause the one or more processors to generate a breakdown report that indicates an impaired operation of the impaired vehicle.

Example 152 is the non-transitory computer-readable medium of example 151, wherein the message is responsive to the breakdown report.

Example 153 is the non-transitory computer-readable medium of any one of examples 150 to 152, wherein the instructions that cause the one or more processors to control movements of the impaired vehicle also includes instructions that cause the one or more processors to plan an approach to a waypoint defined by the waypoint information and to maintain a target speed defined by the speed information.

Example 154 is the non-transitory computer-readable medium of example 153, wherein the waypoint includes a previous location of the helping vehicle.

Example 155 is the non-transitory computer-readable medium of example 154, wherein the waypoint includes a coordinate conversion of the previous location from a first coordinate system of the helping vehicle at a first time to a second coordinate system of the impaired vehicle at a second time.

Example 156 is the non-transitory computer-readable medium of example 151 optionally combined with any of examples 152 to 155, wherein the instructions also cause the one or more processors to transmit (e.g., via a transmitter/transceiver) the breakdown report to a server (e.g. a cloud server) external to the impaired vehicle.

Example 157 is the non-transitory computer-readable medium of example 151 optionally combined with any of examples 152 to 156, wherein the instructions also cause the one or more processors to transmit (e.g., via a transmitter/transceiver) the breakdown report as a broadcast message on a shared communication channel.

Example 158 is the non-transitory computer-readable medium of any one of examples 150 to 157, wherein the virtual towing mode further includes instructions that cause the one or more processors to transmit sensor data to the helping vehicle, wherein the sensor data includes information about an environment around the impaired vehicle.

Example 159 is the non-transitory computer-readable medium of example 151 optionally combined with any of examples 152 to 158, wherein the impaired operation of the impaired vehicle includes a failure of an automated driving system of the impaired vehicle.

Example 160 is the non-transitory computer-readable medium of example 159, wherein the failure of the automated driving system includes a perception system failure, a communication system failure, and/or a planning system failure.

Example 161 is the non-transitory computer-readable medium of any one of examples 150 to 160, wherein the impaired vehicle includes an automated driving system, wherein the instructions for the virtual towing mode includes instructions that also cause the one or more processors to control movements of the impaired vehicle based on the waypoint information and speed information in lieu of the automated driving system.

Example 162 is the non-transitory computer-readable medium of any one of examples 150 to 161, wherein the helping vehicle includes a plurality of helping vehicles, and the offer to provide the virtual towing services is a collective offer to provide the virtual towing services from the plurality of vehicles.

Example 163 is the non-transitory computer-readable medium of example 162, wherein the plurality of helping vehicles includes a leader helping vehicle and a sensing helping vehicle, where the sensing helping vehicle is configured to provide additional sensor data to the leader helping vehicle.

Example 164 is the non-transitory computer-readable medium of any one of examples 150 to 163, wherein the helping vehicle includes at least one of: an unmanned aerial vehicle, an automobile, an autonomous driving vehicle, and a partially autonomous driving vehicle.

Example 165 is the non-transitory computer-readable medium of any one of examples 150 to 164, wherein the instructions for the virtual towing mode includes instructions that also cause the one or more processors to execute a stop maneuver if a distance between a current location of the impaired vehicle and the waypoint falls below a predetermined threshold or if the impaired vehicle fails to receive a communication confirmation from the helping vehicle within a predetermined time period.

Example 166 is the non-transitory computer-readable medium of example 151 optionally combined with any of examples 152 to 165, wherein the breakdown report further includes vehicle characteristics about the impaired vehicle and/or status information about an automated driving system of the impaired vehicle.

Example 167 is the non-transitory computer-readable medium of example 166, wherein the waypoint information and/or the speed information is further based on the vehicle characteristics.

Example 168 is the non-transitory computer-readable medium of any one of examples 150 to 167, wherein the waypoint information and/or the speed information is based on a transformation from a coordinate system of the helping vehicle to a coordinate system of the impaired vehicle.

Example 169 is the non-transitory computer-readable medium of any one of examples 150 to 168, wherein the waypoint information and/or the speed information is based on a joint safety assessment of the helping vehicle and of the impaired vehicle.

Example 170 is the non-transitory computer-readable medium of any one of examples 150 to 169, wherein the waypoint information includes a plurality of waypoints over a time period, wherein each waypoint of the plurality of waypoints is associated with a different time of the time period.

Example 171 is the non-transitory computer-readable medium of example 170, wherein the instructions also cause the one or more processors to generate a trajectory over the time period based on the plurality of waypoints, wherein the trajectory traverses fewer than all of waypoints.

Example 172 is the non-transitory computer-readable medium of any one of examples 150 to 171, wherein the speed information includes a plurality of target speeds over a time period, wherein each target speed of the plurality of target speeds is associated with a different time of the time period.

Example 173 is the non-transitory computer-readable medium of any one of examples 150 to 172, wherein the instructions for the virtual towing mode includes instructions that also cause the one or more processors to, in lieu of a physical connection between the impaired vehicle and the helping vehicle, establish a communication connection for receiving the waypoint information and the speed information from the helping vehicle.

Example 174 is the non-transitory computer-readable medium of any one of examples 150 to 173, wherein the waypoint information is based on a determined geographic location of the impaired vehicle.

Example 175 is a non-transitory computer-readable medium that includes instructions which, if executed, cause one or more processors to transmit a message indicating an offer to provide virtual towing services to the towed vehicle. The instructions also cause the one or more processors to activate a virtual towing mode based on acceptance of the offer. The instructions to activate the virtual towing mode also include instructions that cause the one or more processors to determine a pathway to a repair destination for the towing vehicle together with towed vehicle, determine a waypoint and a speed for the towing vehicle along the pathway based on a joint safety assessment of the towing vehicle and the towed vehicle, determine waypoint information and speed information for the towed vehicle based on a transformation of the waypoint and the speed from a coordinate system of the towing vehicle to a coordinate system of the towed vehicle, transmit the waypoint information and speed information to the towed vehicle, and control movements of the towing vehicle to travel toward the waypoint at the speed and according to the joint safety assessment.

Example 176 is the non-transitory computer-readable medium of example 175, wherein the instructions also cause the one or more processors to receive a breakdown report that indicates impaired operation of an automated driving system of the towed vehicle.

Example 177 is the non-transitory computer-readable medium of example 176, wherein the message is responsive to the breakdown report.

Example 178. The non-transitory computer-readable medium of either one of examples 176 or 177, wherein the pathway is further based on the breakdown report.

Example 179 is the non-transitory computer-readable medium of any one of examples 175 to 178, wherein the joint safety assessment includes a safety evaluation of movements of the towed vehicle and the towing vehicle based on at least one of: a safety envelope that encompasses at least dimensions of the towed vehicle and the towing vehicle; a weight of the towed vehicle and/or of the helping vehicle; traffic objects proximate to the towed vehicle and/or to the helping vehicle; and a traffic environment along the pathway to the repair destination.

Example 180 is the non-transitory computer-readable medium of either of examples 175 or 179, wherein the instructions also cause the one or more processors to determine a towing position of the towing vehicle with respect to the towed vehicle, wherein the towing position is based on at least one of: a breakdown report that indicates impaired operation of an automated driving system of the towed vehicle, a traffic situation around the towed vehicle, a road type where the towed vehicle is positioned, and a lane in which the towed vehicle is positioned.

Example 181 is the non-transitory computer-readable medium of example 180, wherein the towing position includes a rear position located behind the towed vehicle, a front position located in front of the towed vehicle, a side position located beside the towed vehicle.

Example 182 is the non-transitory computer-readable medium of any one of examples 175 to 181, wherein the instructions to activate the virtual towing mode also include instructions that cause the one or more processors to receive vehicle sensor data from the towed vehicle, wherein the instructions to activate the virtual towing mode also include instructions that cause the one or more processors to determine the joint safety assessment based on the towed vehicle sensor data.

Example 183 is the non-transitory computer-readable medium of any one of examples 175 to 182, wherein the instructions also cause the one or more processors to accept the offer based on at least one of: a current location of the towing vehicle, a breakdown location of the towed vehicle, a type of impairment of the towed vehicle; and a geographic distance between the towed vehicle and the towing vehicle.

Example 184 is the non-transitory computer-readable medium of example 176 optionally combined with any of examples 177 to 183, wherein the instructions also cause the one or more processors to receive (e.g., via a receiver/transceiver) the breakdown report from the towed vehicle or a server (e.g. a cloud server) external to the towed vehicle.

Example 185 is the non-transitory computer-readable medium of claim 176 optionally combined with any of examples 177 to 184, wherein the instructions also cause the one or more processors to receive (e.g., via a receiver/transceiver) the breakdown report as a broadcast message on a shared communication channel.

Example 186 is the non-transitory computer-readable medium of any one of examples 175 to 185, wherein the instructions to activate the virtual towing mode also include instructions that cause the one or more processors to receive sensor data from the towed vehicle, wherein the sensor data includes information about an environment around the towed vehicle.

Example 187 is the non-transitory computer-readable medium of example 176 optionally combined with any of examples 177 to 186, wherein the impaired operation of the towed vehicle includes a failure of an automated driving system of the towed vehicle.

Example 188 is the non-transitory computer-readable medium of example 176, wherein the failure of the perception system includes a perception system failure, a communication system failure, and/or a planning system failure.

Example 189 is the non-transitory computer-readable medium of any one of examples 175 to 188, wherein the towing vehicle is configured in the virtual towing mode to coordinate with at least one other helping vehicle to provide virtual towing services

Example 190 is the non-transitory computer-readable medium of example 189, wherein the towing vehicle includes a leader vehicle and the at least one other vehicle includes a sensing vehicle, wherein the leader vehicle is configured to receive additional sensor data from the sensing vehicle.

Example 191 is the non-transitory computer-readable medium of example 189, wherein the towing vehicle includes a sensing vehicle and the at least one other vehicle includes a leader vehicle, wherein the sensing vehicle is configured to transmit additional sensor data to the leader vehicle.

Example 192 is the non-transitory computer-readable medium of any one of examples 175 to 191, wherein the towing vehicle includes at least one of: an unmanned aerial vehicle, an automobile, an autonomous driving vehicle, and a partially autonomous driving vehicle.

Example 193 is the non-transitory computer-readable medium of any one of examples 176 optionally combined with any of claims 177 to 192, wherein the breakdown report further includes vehicle characteristics about the towed vehicle and/or status information about an automated driving system of the towed vehicle.

Example 194 is the non-transitory computer-readable medium of example 193, wherein the joint safety assessment is further based on the vehicle characteristics.

Example 195 is the non-transitory computer-readable medium of any one of examples 175 to 194, wherein the waypoint information includes a plurality of target waypoints over a time period, wherein each target waypoint of the plurality of target waypoints is associated with a different time of the time period.

Example 196 is the non-transitory computer-readable medium of any one of examples 175 to 195, wherein the speed information includes a plurality of target speeds over a time period, wherein each target speed of the plurality of target speeds is associated with a different time of the time period.

Example 197 is the non-transitory computer-readable medium of any one of examples 175 to 196, wherein the instructions to activate the virtual towing mode also include instructions that cause the one or more processors to, in lieu of a physical connection between the towing vehicle and the towed vehicle, establish a communication connection for transmitting the waypoint information and the speed information to the towed vehicle.

Example 198 is the non-transitory computer-readable medium of any one of examples 175 to 197, wherein the waypoint information is based on a determined geographic location of the towed vehicle.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. A device comprising a processor configured to:
receive a message indicating an offer from a helping vehicle to provide virtual towing services to an impaired vehicle; and
activate a virtual towing mode based on acceptance of the offer, wherein the virtual towing mode comprises the processor further configured to:
receive waypoint information and speed information from the helping vehicle; and
control movements of the impaired vehicle based on the waypoint information and the speed information.

2. The device of claim 1, wherein the processor is configured to generate a breakdown report that indicates an impaired operation of the impaired vehicle, wherein the message is responsive to the breakdown report.

3. The device of claim 1, wherein the processor configured to control movements of the impaired vehicle comprises the processor configured to plan an approach to a waypoint defined by the waypoint information and to maintain a target speed defined by the speed information.

4. The device of claim 1, wherein the virtual towing mode further comprises the processor configured to transmit sensor data to the helping vehicle, wherein the sensor data comprises information about an environment around the impaired vehicle.

5. The device of claim 2, wherein the impaired operation of the impaired vehicle comprises a failure of an automated driving system of the impaired vehicle.

6. The device of claim 1, wherein the impaired vehicle comprises an automated driving system, wherein the virtual towing mode comprises the processor further configured to control movements of the impaired vehicle based on the waypoint information and speed information in lieu of the automated driving system.

7. The device of claim 1, wherein the virtual towing mode further comprises the processor further configured to execute a stop maneuver if:
a distance between a current location of the impaired vehicle and the waypoint falls below a predetermined threshold; or
the impaired vehicle fails to receive a communication confirmation from the helping vehicle within a predetermined time period.

8. The device of claim 2, wherein the breakdown report further comprises vehicle characteristics about the impaired vehicle and/or status information about an automated driving system of the impaired vehicle.

9. The device of claim 1, wherein the waypoint information comprises a plurality of waypoints over a time period, wherein each waypoint of the plurality of waypoints is associated with a different time of the time period.

10. The device of claim 9, wherein the processor is further configured to generate a trajectory over the time period based on the plurality of waypoints, wherein the trajectory traverses fewer than all of waypoints.

11. The device of claim 1, wherein the virtual towing services comprise, in lieu of a physical connection between the impaired vehicle and the helping vehicle, a communication connection for receiving the waypoint information and the speed information from the helping vehicle.

12. An apparatus comprising a processor configured to:
transmit a message indicating an offer to provide virtual towing services from a towing vehicle to a towed vehicle; and
activate a virtual towing mode based on acceptance of the offer, wherein the virtual towing mode comprises the processor further configured to:
determine a pathway to a repair destination for the towing vehicle together with towed vehicle;
determine a waypoint and a speed for the towing vehicle along the pathway based on a joint safety assessment of the towing vehicle and the towed vehicle;
determine waypoint information and speed information for the towed vehicle based on a transformation of the waypoint and the speed from a first coordinate system of the towing vehicle to a second coordinate system of the towed vehicle;
transmit the waypoint information and speed information to the towed vehicle; and
control movements of the towing vehicle to travel toward the waypoint at the speed and according to the joint safety assessment.

13. The apparatus of claim 12, wherein the processor is further configured to receive a breakdown report that indicates impaired operation of an automated driving system of the towed vehicle, wherein the message is responsive to the breakdown report.

14. The apparatus of claim 12, wherein the joint safety assessment comprises a safety evaluation of movements of the towed vehicle and the towing vehicle based on at least one of:
a safety envelope that encompasses at least dimensions of the towed vehicle and the towing vehicle; a weight of the towed vehicle and/or of the helping vehicle; traffic objects proximate to the towed vehicle and/or to the helping vehicle; and a traffic environment along the pathway to the repair destination.

15. The apparatus of of claim 12, wherein the processor is further configured to determine a towing position of the towing vehicle with respect to the towed vehicle, wherein the towing position is based on at least one of: a breakdown report that indicates impaired operation of an automated driving system of the towed vehicle, a traffic situation around the towed vehicle, a road type where the towed vehicle is positioned, and a lane in which the towed vehicle is positioned.

16. The apparatus of claim 15, wherein the towing position comprises a rear position located behind the towed vehicle, a front position located in front of the towed vehicle, a side position located beside the towed vehicle.

17. The apparatus of claim 12, wherein the processor is further configured in the virtual towing mode to receive vehicle sensor data from the towed vehicle, wherein the processor is further configured to determine the joint safety assessment based on the towed vehicle sensor data.

18. The apparatus of claim 12, wherein the processor is configured to accept the offer based on at least one of: a current location of the towing vehicle, a breakdown location of the towed vehicle, a type of impairment of the towed vehicle; and a geographic distance between the towed vehicle and the towing vehicle.

19. The apparatus of claim 12, wherein the towing vehicle is configured in the virtual towing mode to coordinate with at least one other helping vehicle to provide the virtual towing services to the towed vehicle.

20. The apparatus of claim 12, wherein the virtual towing services comprise, in lieu of a physical connection between the towed vehicle and the towing vehicle, a communication connection for transmitting the waypoint information and the speed information to the towed vehicle.

21. A non-transitory computer readable medium, comprising instructions which, if executed, cause one or more processors to:
activate a virtual towing mode of a towing vehicle based on acceptance of an offer to provide virtual towing services to an impaired vehicle;
determine a pathway to a repair destination for the towing vehicle together with impaired vehicle;
determine a waypoint and a speed for the towing vehicle along the pathway based on a joint safety assessment of the towing vehicle and the impaired vehicle;
determine converted waypoint information and converted speed information for the towed vehicle based on a transformation of the waypoint and the speed from a first coordinate system of the towing vehicle to a second coordinate system of the impaired vehicle;
transmit the waypoint information and speed information to the impaired vehicle; and
control movements of the towing vehicle to travel toward the waypoint at the speed and according to the joint safety assessment.

22. The non-transitory computer readable medium of claim 21, wherein the instructions further cause the one or more processors to receive a breakdown report that indicates impaired operation of an automated driving system of the towed vehicle, wherein the message is responsive to the breakdown report.

23. The non-transitory computer readable medium of claim 22, wherein the breakdown report further comprises vehicle characteristics about the towed vehicle and/or status information about an automated driving system of the towed vehicle.

24. The non-transitory computer readable medium of claim 23, wherein the instructions further cause the one or more processors to determine the joint safety assessment based on the vehicle characteristics.

25. The non-transitory computer readable medium of claim 22, wherein the virtual towing services comprise, in lieu of a physical connection between the impaired vehicle and the towing vehicle, a communication connection for transmitting the waypoint information and the speed information to the impaired vehicle.
